(19) United States
(12) Patent Application Publication
(10) Pub. No.: US 2016/0164943 A1
(43) Pub. Date: Jun. 9, 2016

(54) TRANSPORT INTERFACE FOR MULTIMEDIA AND FILE TRANSPORT

(71) Applicant: QUALCOMM Incorporated, San Diego, CA (US)

(72) Inventors: Gordon Kent Walker, Poway, CA (US); Thomas Stockhammer, Bergen (DE)

(21) Appl. No.: 14/958,086

(22) Filed: Dec. 3, 2015

Related U.S. Application Data
(60) Provisional application No. 62/088,351, filed on Dec. 5, 2014.
(60) Provisional application No. 62/102,930, filed on Jan. 13, 2015.
(60) Provisional application No. 62/209,620, filed on Aug. 25, 2015.

(51) Int. Cl. H04L 29/06; H04L 29/08

(52) U.S. Cl. CPC H04L 65/608; H04L 69/22; H04L 69/326; H04L 67/10; H04L 67/42; H04L 67/02; H04L 65/607; H04L 65/601

(57) ABSTRACT

A server device for transmitting media data includes a first unit and a second unit. The first unit comprises one or more processing units configured to send descriptive information for media data to the second unit of the server device, wherein the descriptive information indicates a segment of the media data or a byte range of the segment and an earliest time that the segment or the byte range can be delivered or a latest time that the segment or the byte range of the segment can be delivered, and send the media data to the second unit. The second unit thereby delivers the segment or the byte range of the segment according to the descriptive information (e.g., after the earliest time and/or before the latest time).

This application claims the benefit of U.S. Provisional Application 62/088,351, filed Dec. 5, 2014, U.S. Provisional Application 62/102,930, filed Jan. 13, 2015, and U.S. Provisional Application No. 62/209,620, filed Aug. 25, 2015, the entire contents of each of which are hereby incorporated by reference.

### TECHNICAL FIELD

This disclosure relates to transport of media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), High Efficiency Video Coding (HEVC)/ITU-T H.265, and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice may be encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames. There can be use hierarchical references among frames or groups of frames.

After video data has been encoded, the video data may be packetized for transmission or storage. The media data may be assembled into a file conforming to any of a variety of standards, such as the International Organization for Standardization (ISO) base media file format (ISO BMFF) and extensions thereof, such as AVC.

### SUMMARY

In general, this disclosure describes techniques related to delivery of media data, e.g., over a network. A server device typically includes a variety of units involved in delivery of media data. For example, the units may include a first unit for packaging media data and a second unit for sending the packaged media data. The techniques of this disclosure more particularly relate to the first unit providing information to the second unit indicative of when the media data should be delivered.

In one example, a method of transporting media data includes, by a first unit of a server device, sending descriptive information for media data to a second unit of the server device, wherein the descriptive information indicates at least one of a segment of the media data or a byte range of the segment and at least one of an earliest time that the segment or the byte range of the segment can be delivered or a latest time that the segment or the byte range of the segment can be delivered, and sending the media data to the second unit.

In another example, a server device for transporting media data includes a first unit and a second unit. The first unit comprises one or more processing units configured to send descriptive information for media data to the second unit of the server device, wherein the descriptive information indicates a segment of the media data or a byte range of the segment and an earliest time that the segment or the byte range can be delivered or a latest time that the segment or the byte range of the segment can be delivered, and send the media data to the second unit.

In another example, a server device for transporting media data includes a first unit and a second unit. The first unit comprises means for sending descriptive information for media data to the second unit of the server device, wherein the descriptive information indicates a segment of the media data or a byte range of the segment and an earliest time that the segment or the byte range can be delivered or a latest time that the segment or the byte range of the segment can be delivered, and means for sending the media data to the second unit.

In another example, a computer-readable storage medium has stored thereon instructions that, when executed, cause a processor of a first unit of a server device to send descriptive information for media data to a second unit of the server device, wherein the descriptive information indicates at least one of a segment of the media data or a byte range of the segment and at least one of an earliest time that the segment or the byte range of the segment can be delivered or a latest time that the segment or the byte range of the segment can be delivered, and send the media data to the second unit.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a conceptual diagram illustrating elements of example multimedia content.

FIG. 3 is a block diagram illustrating example components of a server device (such as the server device of FIG. 1) and a client device (such as the client device of FIG. 1).

FIG. 4 is a conceptual diagram illustrating examples of differences between times at which data is received at the media access control (MAC)/PHY layer (of the client device of FIG. 3) and times at which a media player outputs media data resulting from the received data.

FIG. 5 is a conceptual diagram illustrating examples of differences between times at which data is received at the MAC/Phy layer (of the client device of FIG. 3), times at which a DASH player (of the client device of FIG. 3) receives input, and times at which the DASH player delivers output.

FIG. 6 is a conceptual diagram illustrating examples of correspondence between Data Delivery Events and Media Delivery Events.

FIG. 7 is a conceptual diagram illustrating MAC/PHY data delivery blocks.

FIG. 8 is a conceptual diagram illustrating an example of a transmit process and a receive process.

FIGS. 9A and 9B illustrate examples of forward error correction (FEC) applied to media data in accordance with the techniques of this disclosure.

FIG. 10 is a conceptual diagram illustrating various segment delivery styles (A-D).

FIG. 11 is a conceptual diagram illustrating a genuine transport buffer model.

FIGS. 12A and 12B are conceptual diagrams that contrast the techniques of this disclosure with the MPEG-2 TS Model.

FIG. 13 is a block diagram of an example receiver IP stack, which may be implemented by a client device, such as the client device of FIG. 3 and/or the client device of FIG. 1.

FIG. 14 is a conceptual diagram illustrating an example transmit system that is implemented according to the constant delay assumption and block delivery based phy.

FIG. 15 is a block diagram illustrating an example transmitter configuration.

FIG. 16 is a conceptual diagram illustrating an example delivery model for data in a system with scheduled packet delivery.

FIG. 17 is a conceptual diagram illustrating more details of a transmit system.

FIG. 18 is a conceptual diagram illustrating staggering of segment times.

FIG. 19 is a conceptual diagram illustrating differences between target times and earliest times when a stream includes media data that can be optional and media that is mandatory.

FIG. 20 is a conceptual diagram of a video sequence with potentially droppable groups of frames.

FIG. 21 is a block diagram illustrating another example system according to the techniques of this disclosure.

FIG. 22 is a flowchart illustrating an example technique for acquisition of media delivery events.

FIG. 23 is a flowchart illustrating an example method for transporting media data in accordance with the techniques of this disclosure.

### DETAILED DESCRIPTION

In general, this disclosure describes techniques related to aspects of transport interface design for multimedia and file delivery. These techniques, in particular, pertain to systems that have timed media and/or file delivery. This is a departure from the historical methods utilized, for example, for systems based on MPEG-2 Transport Stream (TS) of MPEG-2 Systems, which typically assumed constant end-to-end delay, which is far less relevant at this time, when taking into account state-of-the-art transport systems and their related physical (PHY) layer/media access control (MAC).

The techniques of this disclosure may be applied to video or other multimedia and metadata files conforming to video data encapsulated according to any of ISO base media file format, Scalable Video Coding (SVC) file format, Advanced Video Coding (AVC) file format, Third Generation Partnership Project (3GPP) file format, and/or Multiview Video Coding (MVC) file format, or other similar video file formats.

In HTTP streaming, frequently used operations include HEAD, GET, and partial GET. The HEAD operation retrieves a header of a file associated with a given uniform resource locator (URL) or uniform resource name (URN), without retrieving a payload associated with the URL or URN. The GET operation retrieves a whole file associated with a given URL or URN. The partial GET operation receives a byte range as an input parameter and retrieves a continuous number of bytes of a file, where the number of bytes correspond to the received byte range. Thus, movie fragments may be provided for HTTP streaming, because a partial GET operation can get one or more individual movie fragments. In a movie fragment, there can be several track fragments of different tracks. In HTTP streaming, a media presentation may be a structured collection of data that is accessible to the client. The client may request and download media data information to present a streaming service to a user.

In the example of streaming 3GPP data using HTTP streaming, there may be multiple representations for video and/or audio data of multimedia content. As explained below, different representations may correspond to different coding characteristics (e.g., different profiles or levels of a video coding standard), different coding standards or extensions of coding standards (such as multiview and/or scalable extensions), or different bitrates. The manifest of such representations may be defined in a Media Presentation Description (MPD) data structure of Dynamic Adaptive Streaming over HTTP (DASH). A media presentation may correspond to a structured collection of data that is accessible to an HTTP streaming client device. The HTTP streaming client device may request and download media data information to present a streaming service to a user of the client device. A media presentation may be described in the MPD data structure, which may include updates of the MPD.

A media presentation may contain a sequence of one or more periods. Periods may be defined by a Period element in the MPD. Each period may have an attribute start in the MPD. The MPD may include a start attribute and an availabilityStartTime attribute for each period. For live services, the sum of the start attribute of the period and the MPD attribute availabilityStartTime may specify the availability time of the period in network time protocol (NTP) 64 format, in particular, for the first Media Segment of each representation in the corresponding period. For on-demand services, the start attribute of the first period may be 0. For any other period, the start attribute may specify a time offset between the start time of the corresponding Period relative to the start time of the first Period. Each period may extend until the start of the next Period, or until the end of the media presentation in the case of the last period. Period start times may be precise. They may reflect the actual timing resulting from playing the media of all prior periods.

Each period may contain one or more representations for the same media content. A representation may be one of a number of alternative encoded versions of audio or video data. The representations may differ by encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular Period may be assigned to a group indicated by an attribute in the MPD indicative of an adaptation set to which the representations belong. Representations in the same adaptation set are generally considered alternatives to each other, in that a client device can dynamically and seamlessly switch between these representations, e.g., to perform bandwidth adaptation. For example, each representation of video data for a particular period may be assigned to the same adaptation set, such that any of the representations may be selected for decoding to present media data, such as video data or audio data, of the multimedia content for the corresponding period. The media content within one period may be represented by either one representation from group 0, if present, or the combination of at most one representation from each non-zero group, in some examples. Timing data for each representation of a period may be expressed relative to the start time of the period.

A representation may include one or more segments. Each representation may include an initialization segment, or each segment of a representation may be self-initializing. When present, the initialization segment may contain initialization information for accessing the representation. In general, the initialization segment does not contain media data. A segment may be uniquely referenced by an identifier, such as a uniform resource locator (URL), uniform resource name (URN), or uniform resource identifier (URI). The MPD may provide the identifiers for each segment. In some examples, the MPD may also provide byte ranges in the form of a range attribute, which may correspond to the data for a segment within a file accessible by the URL, URN, or URI.

Different representations may be selected for substantially simultaneous retrieval for different types of media data. For example, a client device may select an audio representation, a video representation, and a timed text representation from which to retrieve segments. In some examples, the client device may select particular adaptation sets for performing bandwidth adaptation. That is, the client device may select an adaptation set including video representations, an adaptation set including audio representations, and/or an adaptation set including timed text. Alternatively, the client device may select adaptation sets for certain types of media (e.g., video), and directly select representations for other types of media (e.g., audio and/or timed text).

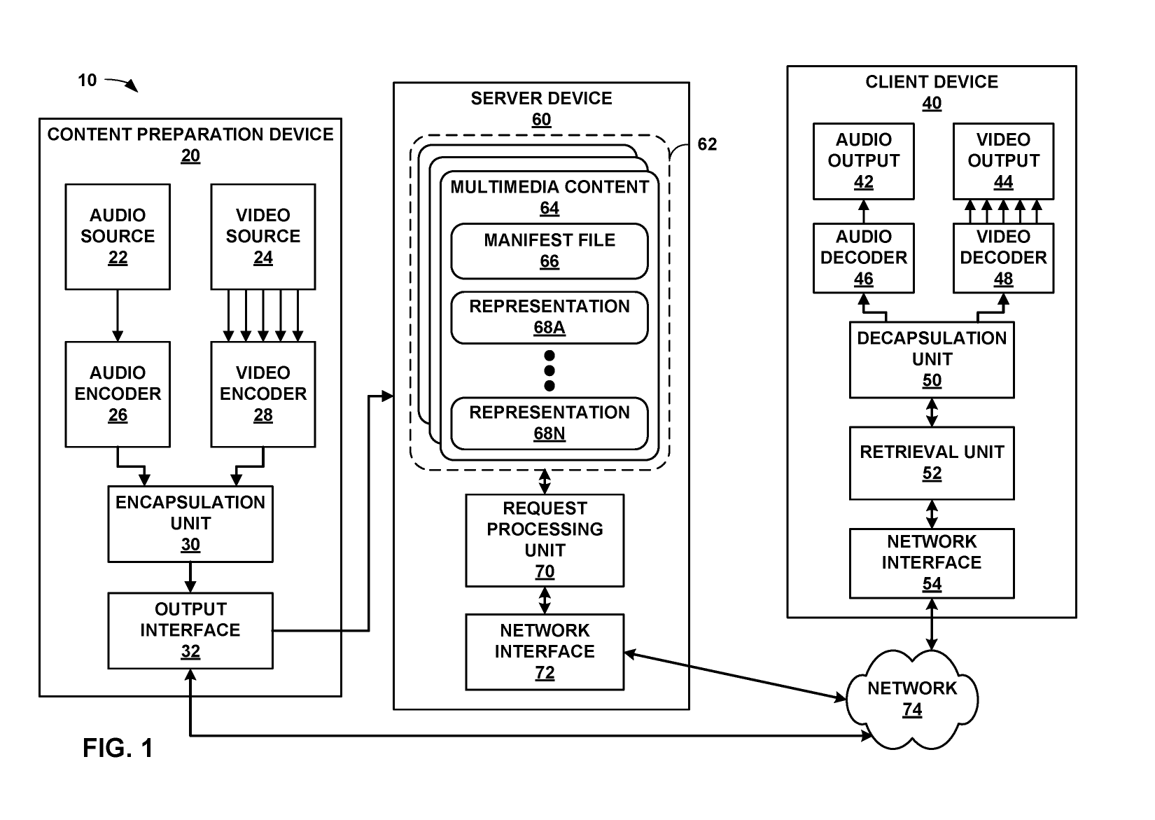

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream or a collection of fragments from a number of objects being delivered. An elementary stream is a single, digitally coded (possibly compressed) component of a representation. For example, the coded video or audio part of the representation can be an elementary stream. An elementary stream may be converted into a Packetized Elementary Stream (PES) before being encapsulated within a video file. Within the same representation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams. In some examples, e.g., in accordance with Real-Time Object Delivery over Unidirectional Transport (ROUTE) protocol, media objects may be streamed in a manner similar in function to an elementary stream. This also bears a resemblance to progressive download and playback. A ROUTE session may include one or more Layered Coding Transport (LCT) sessions. LCT is described in Luby et al., “Layered Coding Transport (LCT) Building Block,” RFC 5651, October 2009.

Many video coding standards, such as ITU-T H.264/AVC and the High Efficiency Video Coding (HEVC) standard (also referred to as ITU-T H.265), define the syntax, semantics, and decoding process for error-free bitstreams, any of which conform to a certain profile or level. Video coding standards typically do not specify the encoder, but the encoder is tasked with guaranteeing that the generated bitstreams are standard-compliant for a decoder. In the context of video coding standards, a “profile” corresponds to a subset of algorithms, features, or tools and constraints that apply to them. As defined by the H.264 standard, for example, a “profile” is a subset of the entire bitstream syntax that is specified by the H.264 standard. A “level” corresponds to the limitations of the decoder resource consumption, such as, for example, decoder memory and computation, which are related to the resolution of the pictures, bit rate, and block processing rate. A profile may be signaled with a profile idc (profile indicator) value, while a level may be signaled with a level idc (level indicator) value.

The H.264 standard, for example, recognizes that, within the bounds imposed by the syntax of a given profile, it is still possible to require a large variation in the performance of encoders and decoders depending upon the values taken by syntax elements in the bitstream such as the specified size of the decoded pictures. The H.264 standard further recognizes that, in many applications, it is neither practical nor economical to implement a decoder capable of dealing with all hypothetical uses of the syntax within a particular profile. Accordingly, the H.264 standard defines a “level” as a specified set of constraints imposed on values of the syntax elements in the bitstream. These constraints may be simple limits on values. Alternatively, these constraints may take the form of constraints on arithmetic combinations of values (e.g., picture width multiplied by picture height multiplied by number of pictures decoded per second). The H.264 standard further provides that individual implementations may support a different level for each supported profile.

A decoder conforming to a profile ordinarily supports all the features defined in the profile. For example, as a coding feature, B-picture coding is not supported in the baseline profile of H.264/AVC but is supported in other profiles of H.264/AVC. A decoder conforming to a level should be capable of decoding any bitstream that does not require resources beyond the limitations defined in the level. Definitions of profiles and levels may be helpful for interpretability. For example, during video transmission, a pair of profile and level definitions may be negotiated and agreed for a whole transmission session. More specifically, in H.264/AVC, a level may define limitations on the number of macroblocks that need to be processed, Decoded Picture Buffer (DPB) size, Coded Picture Buffer (CPB) size, vertical motion vector range, maximum number of motion vectors per two consecutive MBs, and whether a B-block can have sub-macroblock partitions less than 8×8 pixels. In this manner, a decoder may determine whether the decoder is capable of properly decoding the bitstream.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into video files (e.g., segments) of various representations.

Encapsulation unit 30 receives PES packets for elementary streams of a representation from audio encoder 26 and video encoder 28 and forms corresponding Network Abstraction Layer (NAL) units from the PES packets. In the example of H.264/AVC (Advanced Video Coding), coded video segments are organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and Supplemental Enhancement Information (SEI) NAL units, among others. Parameter sets may contain sequence-level header information (in Sequence Parameter Sets (SPS)) and the infrequently changing picture-level header information (in Picture Parameter Sets (PPS)). With parameter sets (e.g., PPS and SPS), infrequently changing information need not to be repeated for each sequence or picture, hence coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

SEI NAL units may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points. In addition, encapsulation unit 30 may form a manifest file, such as a media presentation description (MPD) that describes characteristics of the representations. Encapsulation unit 30 may format the MPD according to Extensible Markup Language (XML).

Encapsulation unit 30 may provide data for one or more representations of multimedia content, along with the manifest file (e.g., the MPD) to output interface 32. Output interface 32 may comprise a network interface or an interface for writing to a storage medium, such as a Universal Serial Bus (USB) interface, a CD, DVD, Blu-Ray writer, burner or stamper, an interface to magnetic or flash storage media, or other interfaces for storing or transmitting media data. Encapsulation unit 30 may provide data of each of the representations of multimedia content to output interface 32, which may send the data to server device 60 via network transmission or storage media. In the example of FIG. 1, server device 60 includes storage medium 62 that stores various multimedia contents 64, each including a respective manifest file 66 and one or more representations 68A-68N (representations 68). In some examples, output interface 32 may also send data directly to network 74.

In some examples, representations 68 may be separated into adaptation sets. That is, various subsets of representations 68 may include respective common sets of characteristics, such as codec, profile and level, resolution, number of views, file format for segments, text type information that may identify a language or other characteristics of text to be displayed with the representation and/or audio data to be decoded and presented, e.g., by speakers, camera angle information that may describe a camera angle or real-world camera perspective of a scene for representations in the adaptation set, rating information that describes content suitability for particular audiences, or the like.

Manifest file 66 may include data indicative of the subsets of representations 68 corresponding to particular adaptation sets, as well as common characteristics for the adaptation sets. Manifest file 66 may also include data representative of individual characteristics, such as bitrates, for individual representations of adaptation sets. In this manner, an adaptation set may provide for simplified network bandwidth adaptation. Representations in an adaptation set may be indicated using child elements of an adaptation set element of manifest file 66.

Server device 60 includes request processing unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64, and include components that conform substantially to those of server device 60. In general, network interface 72 is configured to send and receive data via network 74.

Request processing unit 70 is configured to receive network requests from client devices, such as client device 40, for data of storage medium 62. For example, request processing unit 70 may implement hypertext transfer protocol (HTTP) version 1.1, as described in RFC 2616, “Hypertext Transfer Protocol—HTTP/1.1,” by R. Fielding et al, Network Working Group, IETF, June 1999. That is, request processing unit 70 may be configured to receive HTTP GET or partial GET requests and provide data of multimedia content 64 in response to the requests. The requests may specify a segment of one of representations 68, e.g., using a URL of the segment. In some examples, the requests may also specify one or more byte ranges of the segment, thus comprising partial GET requests. Request processing unit 70 may further be configured to service HTTP HEAD requests to provide header data of a segment of one of representations 68. In any case, request processing unit 70 may be configured to process the requests to provide requested data to a requesting device, such as client device 40.

Additionally or alternatively, request processing unit 70 may be configured to deliver media data via a broadcast or multicast protocol, such as eMBMS. Content preparation device 20 may create DASH segments and/or sub-segments in substantially the same way as described, but server device 60 may deliver these segments or sub-segments using eMBMS or another broadcast or multicast network transport protocol. For example, request processing unit 70 may be configured to receive a multicast group join request from client device 40. That is, server device 60 may advertise an Internet protocol (IP) address associated with a multicast group to client devices, including client device 40, associated with particular media content (e.g., a broadcast of a live event). Client device 40, in turn, may submit a request to join the multicast group. This request may be propagated throughout network 74, e.g., routers making up network 74, such that the routers are caused to direct traffic destined for the IP address associated with the multicast group to subscribing client devices, such as client device 40. DASH refers to Dynamic Adaptive Streaming Over HTTP, e.g., as defined in INTERNATIONAL STANDARD ISO/IEC 23009-1 Second edition 2014-05-01 Information Technology—Dynamic Adaptive Streaming Over HTTP (DASH) Part 1: Media Presentation Description and Segment Formats.

As illustrated in the example of FIG. 1, multimedia content 64 includes manifest file 66, which may correspond to a media presentation description (MPD). Manifest file 66 may contain descriptions of different alternative representations 68 (e.g., video services with different qualities) and the description may include, e.g., codec information, a profile value, a level value, a bit rate, and other descriptive characteristics of representations 68. Client device 40 may retrieve the MPD of a media presentation to determine how to access segments of representations 68.

In particular, retrieval unit 52 may retrieve configuration data (not shown) of client device 40 to determine decoding capabilities of video decoder 48 and rendering capabilities of video output 44. The configuration data may also include any or all of a language preference selected by a user of client device 40, one or more camera perspectives corresponding to depth preferences set by the user of client device 40, and/or a rating preference selected by the user of client device 40. Retrieval unit 52 may comprise, for example, a web browser or a media client configured to submit HTTP GET and partial GET requests. Retrieval unit 52 may correspond to software instructions executed by one or more processors or processing units (not shown) of client device 40. In some examples, all or portions of the functionality described with respect to retrieval unit 52 may be implemented in hardware, or a combination of hardware, software, and/or firmware, where requisite hardware may be provided to execute instructions for software or firmware.

Retrieval unit 52 may compare the decoding and rendering capabilities of client device 40 to characteristics of representations 68 indicated by information of manifest file 66. Retrieval unit 52 may initially retrieve at least a portion of manifest file 66 to determine characteristics of representations 68. For example, retrieval unit 52 may request a portion of manifest file 66 that describes characteristics of one or more adaptation sets. Retrieval unit 52 may select a subset of representations 68 (e.g., an adaptation set) having characteristics that can be satisfied by the coding and rendering capabilities of client device 40. Retrieval unit 52 may then determine bitrates for representations in the adaptation set, determine a currently available amount of network bandwidth, and retrieve segments from one of the representations having a bitrate that can be satisfied by the network bandwidth.

In general, higher bitrate representations may yield higher quality video playback, while lower bitrate representations may provide sufficient quality video playback when available network bandwidth decreases. Accordingly, when available network bandwidth is relatively high, retrieval unit 52 may retrieve data from relatively high bitrate representations, whereas when available network bandwidth is low, retrieval unit 52 may retrieve data from relatively low bitrate representations. In this manner, client device 40 may stream multimedia data over network 74 while also adapting to changing network bandwidth availability of network 74.

Additionally or alternatively, retrieval unit 52 may be configured to receive data in accordance with a broadcast or multicast network protocol, such as eMBMS or IP multicast. In such examples, retrieval unit 52 may submit a request to join a multicast network group associated with particular media content. After joining the multicast group, retrieval unit 52 may receive data of the multicast group without further requests issued to server device 60 or content preparation device 20. Retrieval unit 52 may submit a request to leave the multicast group when data of the multicast group is no longer needed, e.g., to stop playback or to change channels to a different multicast group.

Network interface 54 may receive and provide data of segments of a selected representation to retrieval unit 52, which may in turn provide the segments to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, retrieval unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder audio encoder 26, audio decoder 46, encapsulation unit 30, retrieval unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

A media presentation may include a media presentation description (MPD), which may contain descriptions of different alternative representations (e.g., video services with different qualities) and the description may include, e.g., codec information, a profile value, and a level value. An MPD is one example of a manifest file, such as manifest file 66. Client device 40 may retrieve the MPD of a media presentation to determine how to access movie fragments of various presentations. Movie fragments may be located in movie fragment boxes (moof boxes) of video files.

Manifest file 66 (which may comprise, for example, an MPD) may advertise availability of segments of representations 68. That is, the MPD may include information indicating the wall-clock time at which a first segment of one of representations 68 becomes available, as well as information indicating the durations of segments within representations 68. In this manner, retrieval unit 52 of client device 40 may determine when each segment is available, based on the starting time as well as the durations of the segments preceding a particular segment.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium 34, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via retrieval unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

It is assumed, for the purposes of the techniques of this disclosure, that client device 40 (or other receiving device) and server device 60 (or content preparation device 20 or other transmitting device) have clocks that are accurate according to Coordinated Universal Time (UTC). Time may be established via global positioning system (GPS) or similar techniques in the transmitter (e.g., server device 60). Time may be established, for example, via Advanced Television Systems Committee (ATSC) 3.0 techniques in the physical layer of client device 40 (e.g., within network interface 54). Although the DASH protocol mandates this requirement, the actual method for achieving synchronized time is currently undefined by the DASH standard. Of course, the ATSC 3.0 time at client device 40 is nominally a flight time behind the time of server device 60. However, for the techniques of this disclosure, this is the desired result. That is, local time in client device 40 will accurately describe the location of data blocks at the physical layer. The techniques of this disclosure are described in greater detail below.

In some examples, server device 60 and client device 40 are configured to use robust header compression (ROHC) to compress/decompress header data of packets. ROHC techniques include the use of context information to perform compression. Thus, it is important that when server device 60 uses a particular context to compress header information of a packet, client device 40 uses the same context to decompress the header information of the packet. Thus, when client device 40 performs random access at a random access point (RAP), information for determining the context for decompressing header information for one or more packets including the RAP should be provided. Accordingly, the techniques of this disclosure include providing ROHC context information along with a RAP.

For example, when sending a media presentation description (MPD) (or other manifest file) and an initialization segment (IS), server device 60 may send ROHC context initialization data immediately preceding the MPD/manifest file. Likewise, client device 40 may receive the ROHC context initialization data immediately prior to an MPD/manifest file and IS. “Immediately prior” may mean that data for the ROHC context initialization is received earlier than and contiguous to the MPD/manifest file and IS.

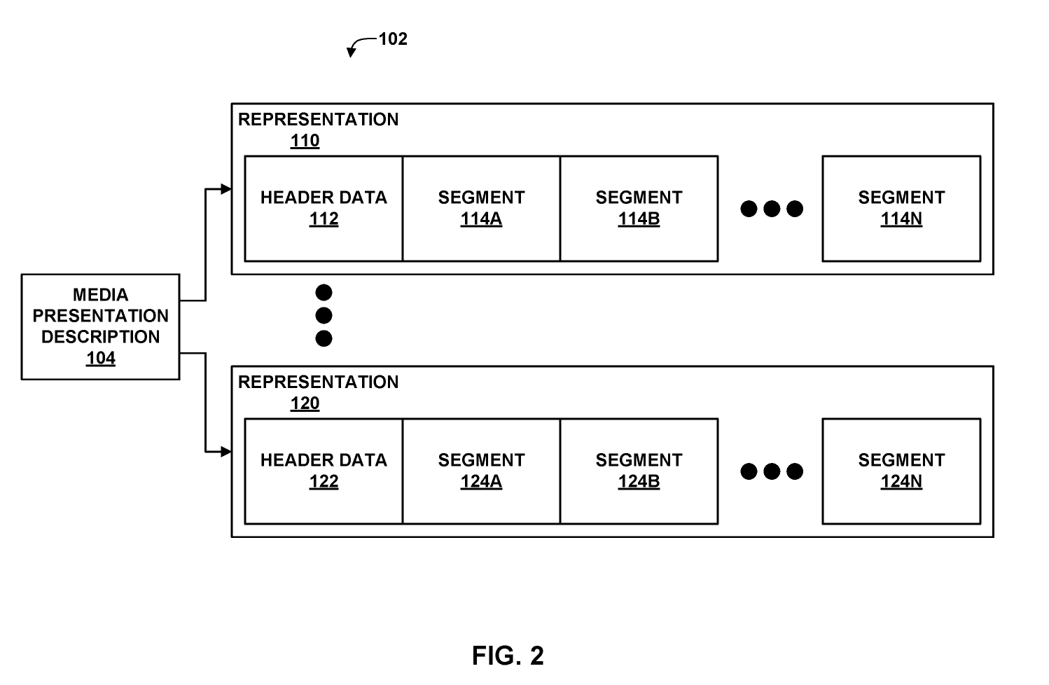

FIG. 2 is a conceptual diagram illustrating elements of example multimedia content 102. Multimedia content 102 may correspond to multimedia content 64 (FIG. 1), or another multimedia content stored in memory 62. In the example of FIG. 2, multimedia content 102 includes media presentation description (MPD) 104 and a plurality of representations 110-120. Representation 110 includes optional header data 112 and segments 114A-114N (segments 114), while representation 120 includes optional header data 122 and segments 124A-124N (segments 124). The letter N is used to designate the last movie fragment in each of representations 110,120 as a matter of convenience. In some examples, there may be different numbers of movie fragments between representations 110,120.

MPD 104 may comprise a data structure separate from representations 110-120. MPD 104 may correspond to manifest file 66 of FIG. 1. Likewise, representations 110-120 may correspond to representations 68 of FIG. 1. In general, MPD 104 may include data that generally describes characteristics of representations 110-120, such as coding and rendering characteristics, adaptation sets, a profile to which MPD 104 corresponds, text type information, camera angle information, rating information, trick mode information (e.g., information indicative of representations that include temporal sub-sequences), and/or information for retrieving remote periods (e.g., for targeted advertisement insertion into media content during playback).

Header data 112, when present, may describe characteristics of segments 114, e.g., temporal locations of random access points (RAPs, also referred to as stream access points (SAPs)), which of segments 114 includes random access points, byte offsets to random access points within segments 114, uniform resource locators (URLs) of segments 114, or other aspects of segments 114. Header data 122, when present, may describe similar characteristics for segments 124. Additionally or alternatively, such characteristics may be fully included within MPD 104.

Segments 114, 124 include one or more coded video samples, each of which may include frames or slices of video data. Each of the coded video samples of segments 114 may have similar characteristics, e.g., height, width, and bandwidth requirements. Such characteristics may be described by data of MPD 104, though such data is not illustrated in the example of FIG. 2. MPD 104 may include characteristics as described by the 3GPP Specification, with the addition of any or all of the signaled information described in this disclosure.

Each of segments 114, 124 may be associated with a unique uniform resource locator (URL). Thus, each of segments 114, 124 may be independently retrievable using a streaming network protocol, such as DASH. In this manner, a destination device, such as client device 40, may use an HTTP GET request to retrieve segments 114 or 124. In some examples, client device 40 may use HTTP partial GET requests to retrieve specific byte ranges of segments 114 or 124.

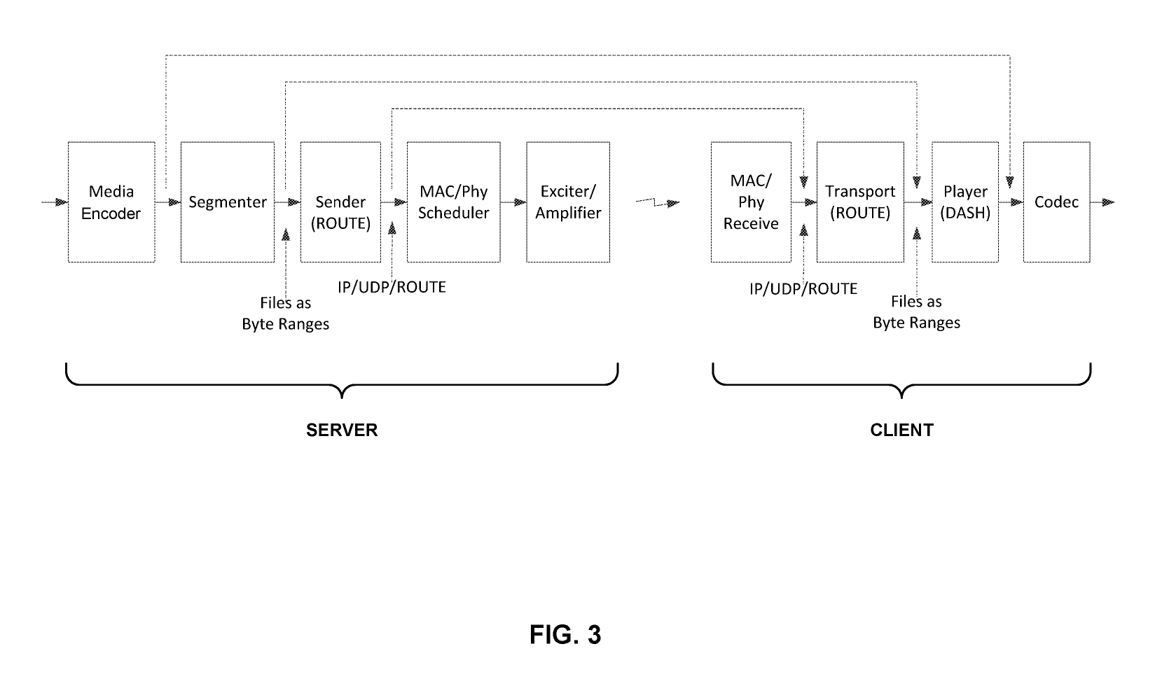

FIG. 3 is a block diagram illustrating example components of a server device (such as server device 60 of FIG. 1) and a client device (such as client device 40 of FIG. 1). The server device, in this example, includes a media encoder, a segmenter, a sender (which, in this example, utilizes the ROUTE transmission protocol), a MAC/PHY scheduler, and an exciter/amplifier. The client device, in this example, includes a MAC/PHY receiver, a transport receiver (which, in this example, utilizes the ROUTE protocol), a media player (which, in this example, is a DASH client), and a codec.

Any or all of the various elements of the server device (e.g., the media encoder, segmenter, sender, and MAC/Phy scheduler) may be implemented in hardware or in a combination of hardware and software. For instance, these units may be implemented in one or more microprocessors, digital signal processors (DSPs), application specific integrated circuits (ASICs), field programmable gate arrays (FPGAs), and/or discrete logic circuitry, or combinations thereof. Additionally or alternatively, these units may be implemented in software executed by hardware. Instructions for the software may be stored on a computer-readable storage medium, and executed by one or more processing units (which may comprise hardware such as that discussed above).

The Media Encoder makes compressed media with playback time information. The Segmenter packages this in files, likely ISO BMFF (Base Media File Format). The Segmenter delivers files as byte ranges to the Sender. The Sender wraps the files as byte ranges for delivery in IP/UDP/ROUTE. The MAC/PHY takes the IP packets and transmits them to the receiver via RF. Connecting at the dotted lines works end to end. This is a simplified discussion for the purpose of giving the blocks names.

In accordance with the techniques of this disclosure, the server device includes a first unit and a second unit related to delivery of media data. The first unit sends descriptive information for media data to the second unit. The first and second units may correspond, respectively, to the Segmenter and the Sender or the Sender and the MAC/PHY scheduler, in this example. The descriptive information indicates at least one of a segment of the media data or a byte range of the segment and at least one of an earliest time that the segment or the byte range of the segment can be delivered or a latest time that the segment or the byte range of the segment can be delivered. The first unit also sends the media data to the second unit.

It should be understood that the server device may further encapsulate media segments, or portions thereof such as particular byte ranges, for network transport. For example, the server device may encapsulate data of the media segments in the form of one or more packets. In general, packets are formed by encapsulating a payload with data according to one or more protocols at various levels of a network stack, e.g., according to the Open Systems Interconnection (OSI) model. For example, a payload (e.g., all or a portion of an ISO BMFF file) may be encapsulated by a Transmission Control Protocol (TCP) header and an Internet protocol (IP) header. It should be understood that the descriptive information also applies to the data used to encapsulate the payload. For example, when the descriptive information indicates an earliest time at which a segment, or a byte range of the segment, can be delivered, the earliest time also applies to any data used to encapsulate the segment or the byte range (e.g., data according to one or more network protocols). Likewise, when the descriptive information indicates a latest time at which a segment, or a byte range of the segment, can be delivered, the latest time also applies to any data used to encapsulate the segment or the byte range.

In this manner, the second unit may be configured to deliver the media data to the client device according to the descriptive information. For example, the second unit may ensure that the segment or the byte range of the segment is not delivered earlier than the earliest time, and/or ensure that the segment or the byte range is delivered before the latest time.

By sending the data according to the descriptive information (e.g., after an earliest time and/or before a latest time), the server device may ensure that the media data arrives at the client device at a time at which the client can use the media data. If the media data arrived earlier than the earliest time or later than the latest time, the client device may discard the media data, because it may be unusable. Moreover, if the media data arrives after the latest time (or is discarded), the media data may be unavailable for use as reference media data for decoding of subsequent media data. For example, if the media data included one or more reference pictures, subsequent pictures may not be accurately decodable, because the reference pictures would not be available for reference. In this manner, the techniques of this disclosure may avoid wasted bandwidth and improve a user's experience.

The descriptive information may further include any or all of a fraction of the segment or of the byte range that is subject to a specific media encoder, a target time that the segment or the byte range should be delivered at or immediately after, a latest time that the segment or the byte range can be delivered, a presentation time stamp for data within the segment or the byte range, a priority of a media stream including the segment relative to other media streams with respect to target delivery times for data of the media streams, and/or a decode time stamp for data within the segment or the byte range. Thus, the second unit may deliver the media data according to any or all of this additional information. For example, the second unit may ensure that the media data is delivered as closely to the target time as possible, and/or before the presentation time and/or the decode time. Likewise, the second unit may deliver the media data according to the priority information. For instance, if only one discrete unit of a plurality of discrete units of media data can be delivered on time, the second unit may determine which of the discrete units has a highest priority and deliver that discrete unit before the other discrete units. Here, the term “discrete unit” of media data may refer to, for example, a segment or a byte range of a segment.

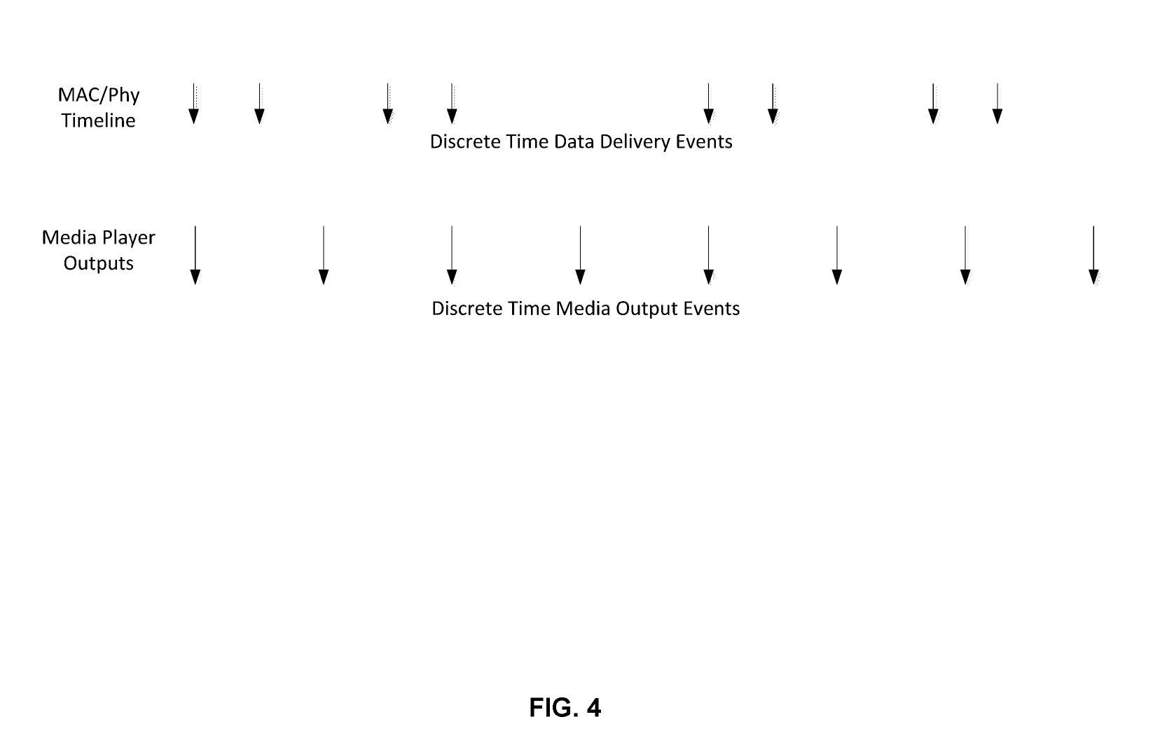

FIG. 4 is a conceptual diagram illustrating examples of differences between times at which data is received at the MAC/PHY layer (of the client device of FIG. 3) and times at which a media player outputs media data resulting from the received data. The MAC/Phy layer and the media player may inter-operate to implement a transport buffer model, which may conform two quasi-independent timelines into a system that works. These two timelines include a media delivery and consumption timeline (bottom of FIG. 4) showing discrete time media output events and a MAC/PHY layer data delivery timeline (top of FIG. 4) showing discrete time data delivery events.

FIG. 4 illustrates the receiver perspective (e.g., the perspective of the client device of FIG. 3, which may correspond to client device 40 of FIG. 1). The MAC/Phy timeline could be thought of as the impulse response of the physical layer at the output of the MAC in the receiver, with bursts of data at specific times. The Media Player Output timeline could be video frames or audio samples at specific times. Arrows in the top portion of FIG. 4 represent data delivery events (in the MAC/Phy timeline) or, e.g., video frames in the media player output timeline. Arrows in the bottom portion of FIG. 4 represent media player output events, e.g., presentations of media data at particular times.

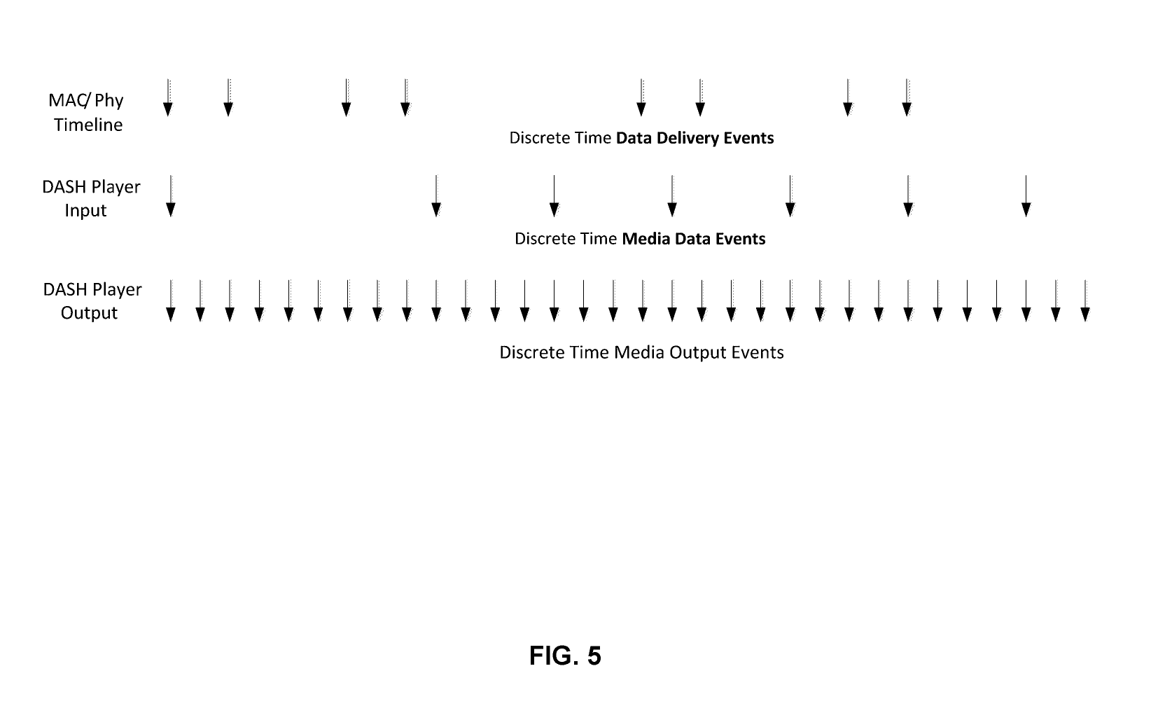

FIG. 5 is a conceptual diagram illustrating examples of differences between times at which data is received at the MAC/Phy layer (of the client device of FIG. 3) (i.e., discrete time data delivery events in the MAC/PHY timeline in the top portion of FIG. 5), times at which a DASH player (of the client device of FIG. 3) (i.e., discrete time media data events in the DASH player input timeline in the vertically middle portion of FIG. 5) receives input, and times at which the DASH player delivers output (i.e., discrete time media output events in the DASH player output timeline in the bottom portion of FIG. 5). Media output generally cannot be directly conformed to data delivery events of the MAC/Phy layer. This is because the output discrete time media events may have many input media samples. For example, audio may have thousands of samples per audio frame. As another example, an output video frame may have N input video frames required to describe the output video frame. The transport buffer model allows conformance between MAC/Phy discrete time Data Delivery Events and DASH player discrete time Media Delivery Events.

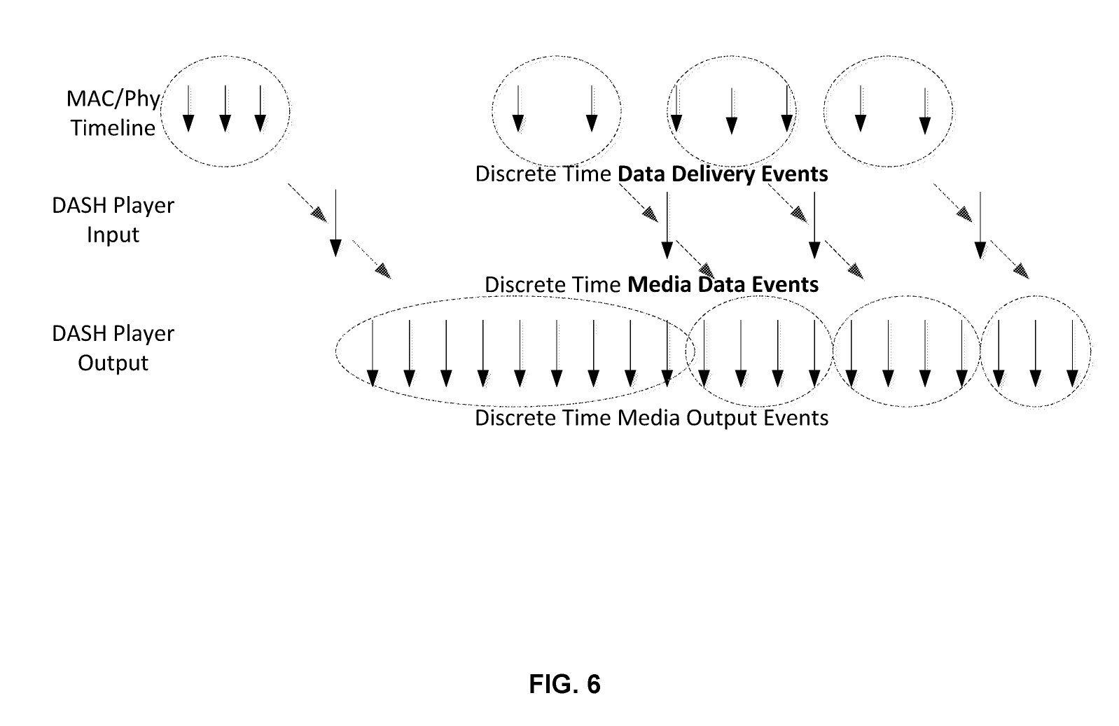

FIG. 6 is a conceptual diagram illustrating examples of correspondence between Data Delivery Events and Media Delivery Events. There are certain collections of data that drive events, such as starting and playing media and a next media frame or group of frames. The byte range transfer mechanism of the ROUTE sender/receiver interfaces allows the Segmenter (FIG. 3) to define discrete units of media that are meaningful to the DASH player. An example of a meaningful discrete unit (Media Data Events) is a unit used to start video playback, which may include an MPD, an IS, a Movie box (Moof), and up to 6 frames of compressed video for HEVC. FIG. 6 illustrates a receiver view and time relationships/correspondence among the various layers. In particular, FIG. 6 shows discrete time data delivery events in a MAC/PHY timeline, discrete time media data events in a DASH player input timeline, and discrete time media output events in a DASH player output timeline.

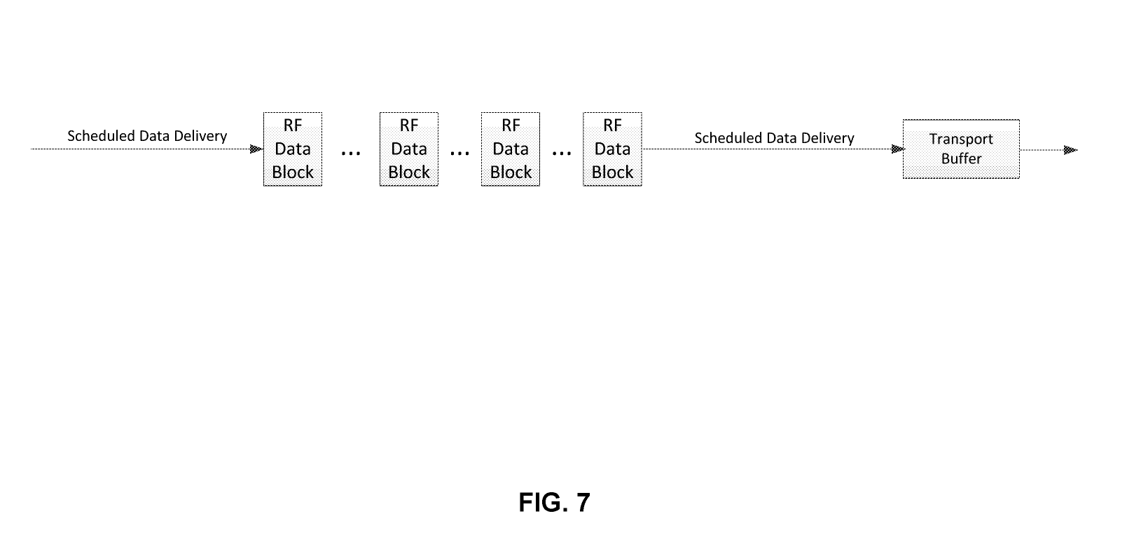

FIG. 7 is a conceptual diagram illustrating MAC/Phy data delivery blocks. In accordance with the techniques of this disclosure, these blocks are not individual MPEG-2 TS (Transport Stream) packets anymore (although in ATSC 1.0 they were). FIG. 7 illustrates modern physical layers transport blocks of data from an input port to and output port as defined by the MAC address. The size of these data blocks may be in the range of 2 KB to 8 KB, but in any case much larger than MPEG-2 TS packets. These blocks of data may contain IP packets. The MAC address may be mapped to an IP Address and port number. The delivery time of the content of a block is known at the MAC/Phy output in terms of delay relative to MAC/Phy input. FIG. 7 represents an abstracted model of data delivery blocks. Discrete units of data that happen to be IP packets with known delivery times are delivered to the receiver.

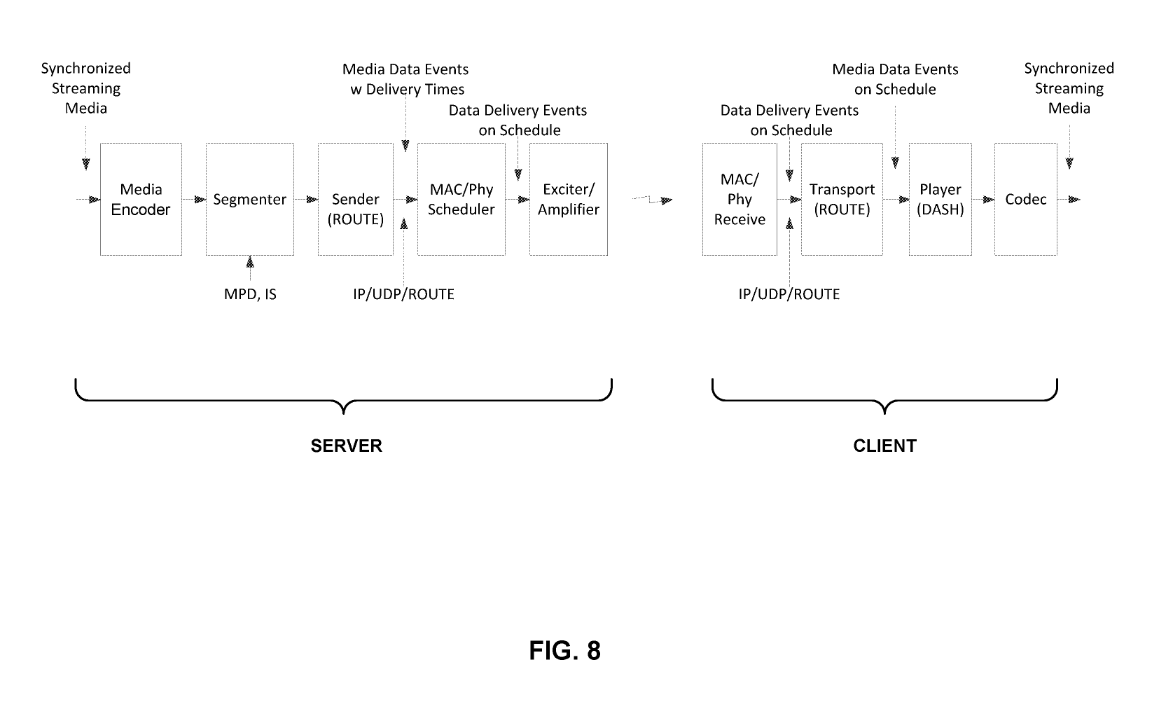

FIG. 8 is a conceptual diagram illustrating an example of a transmission process and a reception process. In the transmit process performed by the server device (e.g., of FIG. 3), the Segmenter is configured with data defining the data structure of the compressed media and the time delivery requirements of the defined media events, e.g., a particular audio frame is required at a particular time at the input to the codec. Special events such as, for example, a random access point (RAP) at the media layer, have additional required data, but the Segmenter can detect the presence of the RAP and can prepend the additional required data, e.g., MPD, IS, Moof, or the like. The MAC/Phy scheduler assigns specific data to specific blocks at specific times. These blocks of data have known receive times at output of Phy/MAC.

In the receive process performed by the client device (e.g., of FIG. 3), the Phy/MAC layer receives data blocks and posts them up immediately (on schedule), that is, by providing the data blocks to the transport unit. These IP/UDP/ROUTE packets go directly into ROUTE transport buffer. The Media Delivery Event is available to the DASH player on schedule. The player passes up media to codec on schedule. The codec then decodes on schedule.

There are certain boundary conditions for the transmission and reception processes. For Period boundaries, should there be any switching of media (e.g., between Representations) at a Period boundary—for example, for ad insertion—in order for the switching to be seamless, the first byte of the Period cannot be delivered early. If the first byte is delivered early, the ad might not start up correctly. The end point is less sensitive, because the starting Transport RAP (T-RAP) of the next period (whether ad or return to program) will start the decoder cleanly, but it would be better if the last byte were received during the correct target period. Furthermore, for IP fragment and defragment, the IP encapsulation and de-encapsulation is handled in the ROUTE sender and ROUTE receiver, respectively. The ROUTE sender organizes IP packets so T-RAPS and Period boundaries are clean. The Transport receiver might see a fragment of a next media delivery event (MDE) media event early, but never at a Period boundary.

Safe Start: the definition of the media event timeline and physical layer scheduling may guarantee that the media needed to start arrives at the correct time. So, up to this point, if a client device has data, the client device can play the data immediately. The system as described to this point could accomplish this hypothetically by the enforcement of the early and late times, but this could place unrealistic demands on the physical layer, which could result in too aggressive media compression, which is the Physical Layer/MAC Scheduler means to conform encoded media to required presentation schedule.

Relaxed scheduling: In order for the physical layer to have the best chance of being able to schedule all the data, it would be nice if there were some flexibility in delivery time. Not every byte can be delivered to the receiver at the same time. For example, if phy delivery rate is 20 Mbs/sec and a service takes 3 Mbs/sec, delivery can run at, on average, 7× real time. In this example use case, a 0.5 second of time margin would be very generous for 0.5 second Segment.

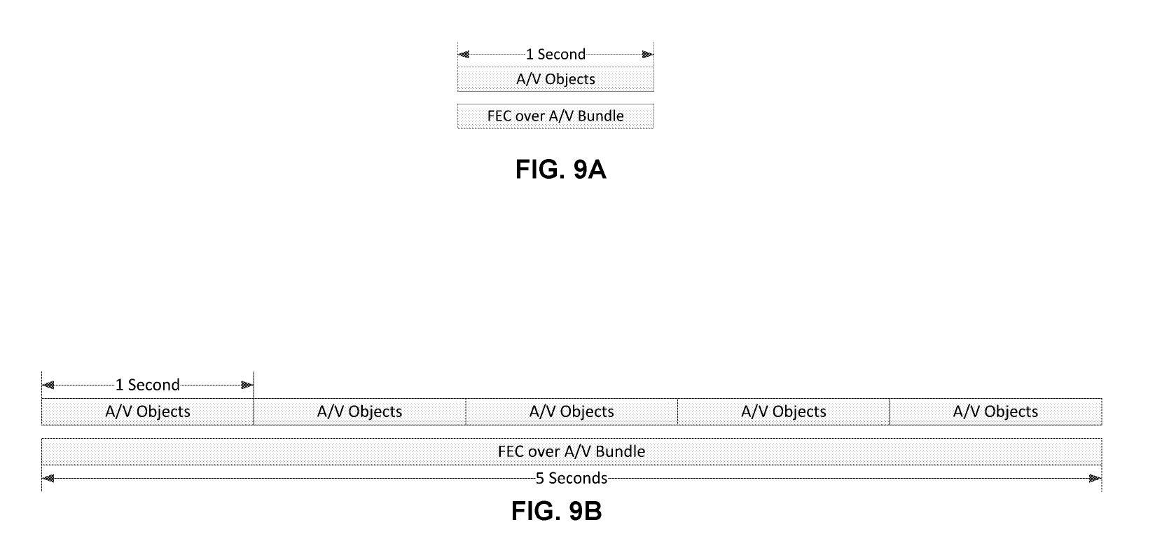

FIGS. 9A and 9B illustrate examples of forward error correction (FEC) applied to media data in accordance with the techniques of this disclosure. Example scenarios when performing a safe start are described below. In one example, there is an early start. That is, the client device may attempt to play media data immediately upon receiving a Media Delivery Event starting with a T-RAP. In the worst case, this results in a short stall. The maximum duration of the stall depends on the time margin. The stall duration may be defined as the difference between the actual start point and the functionally required long term start time. It is possible for the Physical Layer Scheduler to assure a safe start to a rigidly conformed media size vs. media presentation time line, but it may not result in the best possible video quality. The key aspect of concern here is that the early/late mechanism is sufficiently flexible to allow the desired outcome(s) to occur. The plural aspect of outcome is related to the fact that there can be different goals and all can be served effectively by these mechanisms.

In a Safe Start, the client device plays media data after the scheduled delivery of the last byte. Receipt of the last byte of a Media Delivery Event may be guaranteed. The delivery window duration may be dynamic. The late time is likely on a fixed schedule most of the time except possibly Period ends. Similarly the early time can be flexible, except upon Period starts. This is to say flexibility is possible, but possibly constrained at period boundaries. FIG. 9A shows how FEC has no impact if an A/V object is aligned with FEC over an A/V Bundle. FIG. 9B shows how FEC may result in zero to four seconds of delay if up to five A/V objects are aligned with a FEC over A/V Bundle, which may increase capacity (which is good for recording).

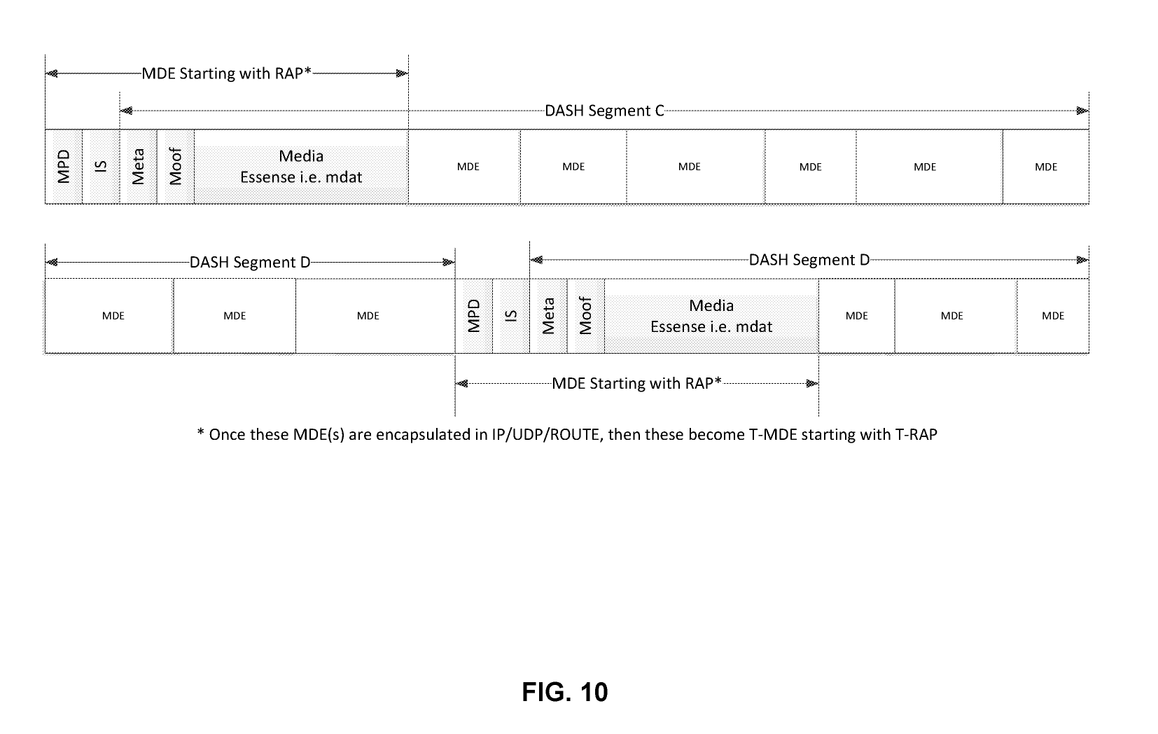

FIG. 10 is a conceptual diagram illustrating various segment delivery styles. In order to avoid startup delay, the MPD and the IS should immediately precede the RAP. Thus, FIG. 10 illustrates two examples in which the MPD and the IS precede the RAP. If Robust Header Compression (ROHC) is utilized, ROHC context initialization data may be inserted immediately before the MPD in both examples. In this manner, a ROHC decompressor (or decoder) can receive the ROHC context initialization data and use this initialization data to properly decompress the header. Context information may be specific to a ROUTE session or per LCT session, where a ROUTE session may include one or more LCT sessions. Thus, context information may be delivered prior to the MPD for a single ROUTE session and/or for each of one or more LCT sessions of the ROUTE session.

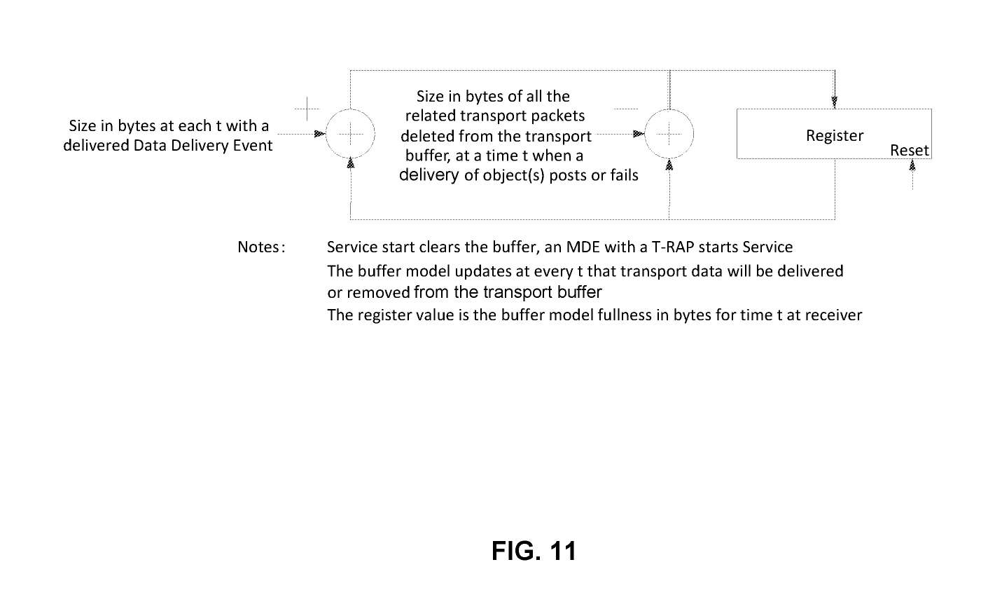

FIG. 11 is a conceptual diagram illustrating a genuine transport buffer model. This is made simple through the techniques of this disclosure. There is only one buffer as far as start-up and overflow is concerned and it is the transport buffer. MAC/phy scheduling guarantees start up, with no buffer model involvement. There is only one bound that matters. Media goes into buffer at scheduled delivery time, and gets deleted when it posts as a file in the output area. A service start, i.e., an MDE starting with T-RAP, clears the buffer. The buffer model updates at every time t that data will be delivered or posted to the transport buffer. The register value is the buffer model fullness in bytes for time t at the receiver device (client device). The buffer contains all the IP/UDP/ROUTE packets related to the current Delivery and all other currently unresolved Deliveries in this session including all related AL-FEC for each currently active Delivery. The buffer model decrements, by the size of all the related packets to a posted object or objects when their status is resolved. In this usage, when the ROUTE transport receiver has determined the status and acted accordingly, i.e., post or abandon the object(s), it is “resolved.” The corresponding related transport data is deleted and buffer model register is decremented accordingly.

In this manner, by establishing MAC/Phy scheduling for the physical layer that is accurate for the MAC/Phy being used, there are no start up conditions as far as the buffer model is concerned. Buffer fullness may be directly calculated, because the time line events are guaranteed. A known size media event goes in at known times. Media is deleted at known times, i.e., when the Segment is posted to an output area.

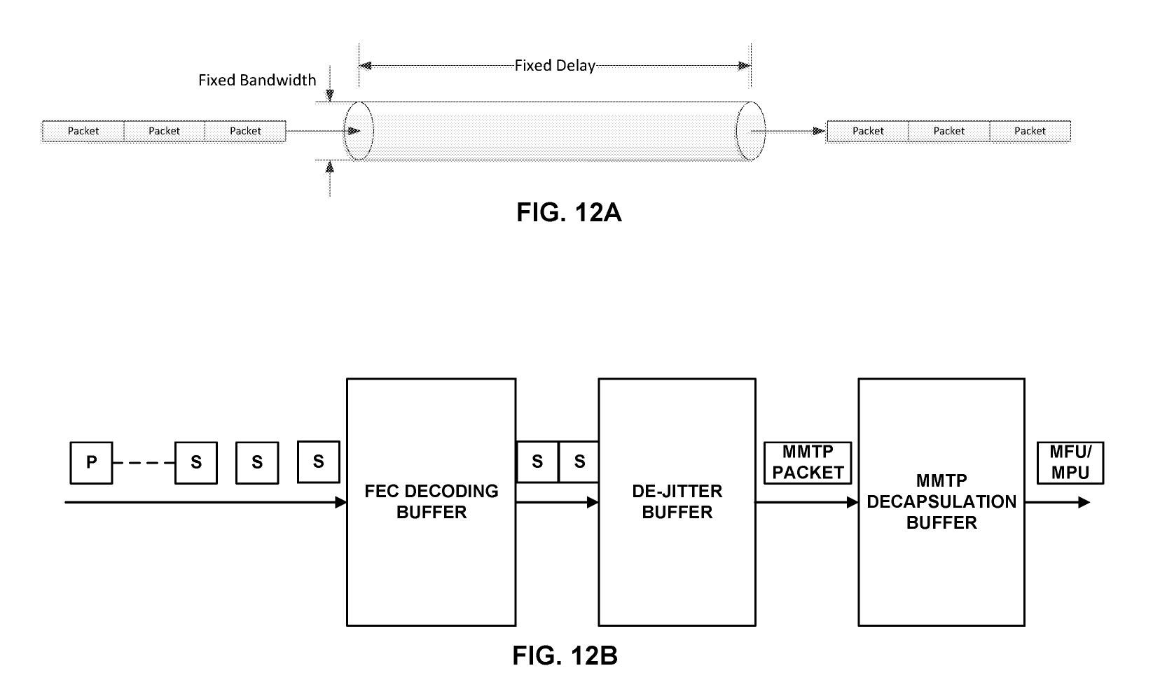

FIGS. 12A and 12B are conceptual diagrams that contrast the techniques of this disclosure with the MPEG-2 TS Model. In In FIG. 12A, there is a fixed delay between packets being sent and received. This is a perfectly fine model for MPEG-2 TS and it has served the industry well. However, attempting to adapt it to ATSC 3.0 may have some undesirable consequences, as shown in FIG. 12B. FIG. 12B includes a forward error correction (FEC) decoding buffer, a de-jitter buffer, and an MPEG Media Transport Protocol (MMTP) decapsulation buffer. The inherently bursty aspects of the ATSC 3.0 physical layer have to be smoothed by a low pass filter in order to make the MPEG-2 TS model valid. This physical layer smoothing ultimately delays the delivery of media to the player.

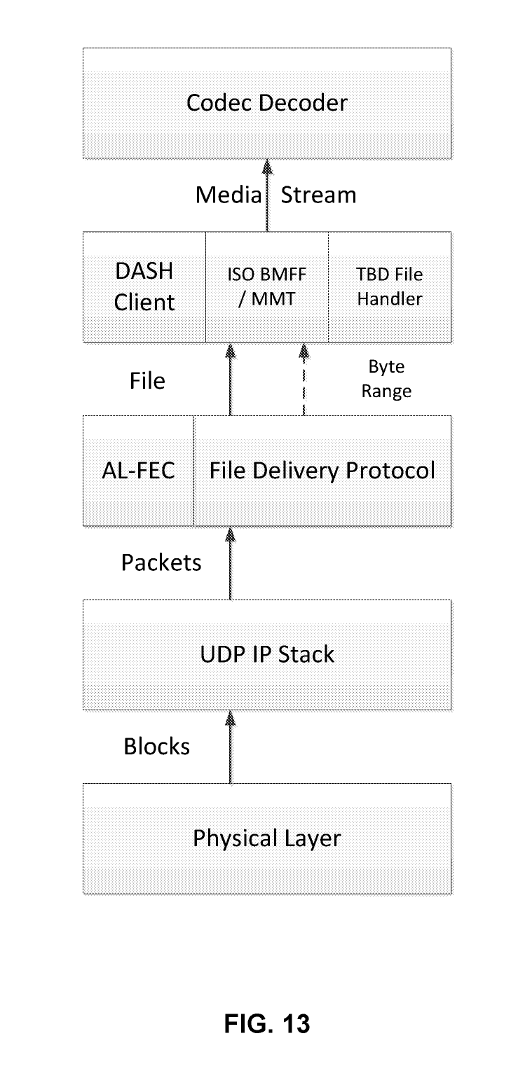

FIG. 13 is a block diagram of an example receiver IP stack, which may be implemented by a client device, such as the client device of FIG. 3 and/or client device 40 of FIG. 1. FIG. 13 illustrates a physical layer that provides blocks of data to a UDP IP stack, which provides packets to an AL-FEC and File Delivery Protocol layer, which provides files or byte ranges of files to a DASH client/ISO-BMFF/MMT/File Handler layer, which provides a media stream to a codec decoder. There is a possibility that the interface between the file delivery protocol layer and file handler layer may allow the pass up of files and or portions of files (e.g., byte ranges of the files). Further, these files or portions of files may have a deadline in time for receipt at the receiver and also a preferred order of receipt. The files may represent Segments of representations of media content, e.g., in accordance with DASH.

The historical approach to this sort of system was a buffer model that assumed constant delay across the physical layer via fixed delay and bandwidth pipe, as depicted in FIG. 12A. These systems expressed MPEG-2 TS packet(s) at RF and often treated the entire input stream as a single series of MPEG2 transport stream packets. These MPEG 2 transport streams possibly contained packets with several different unique packet IDs or so called PIDs.

Modern physical layers in general do not express MPEG-2 TS as a feature at RF. If they are carried at all, it is inside some larger container, for example, 2K bytes or 8K bytes, which might instead contain IP packets. These blocks of RF data may be fragmented, although when attempting to achieve direct access to certain addresses it is more battery efficient not to do so.

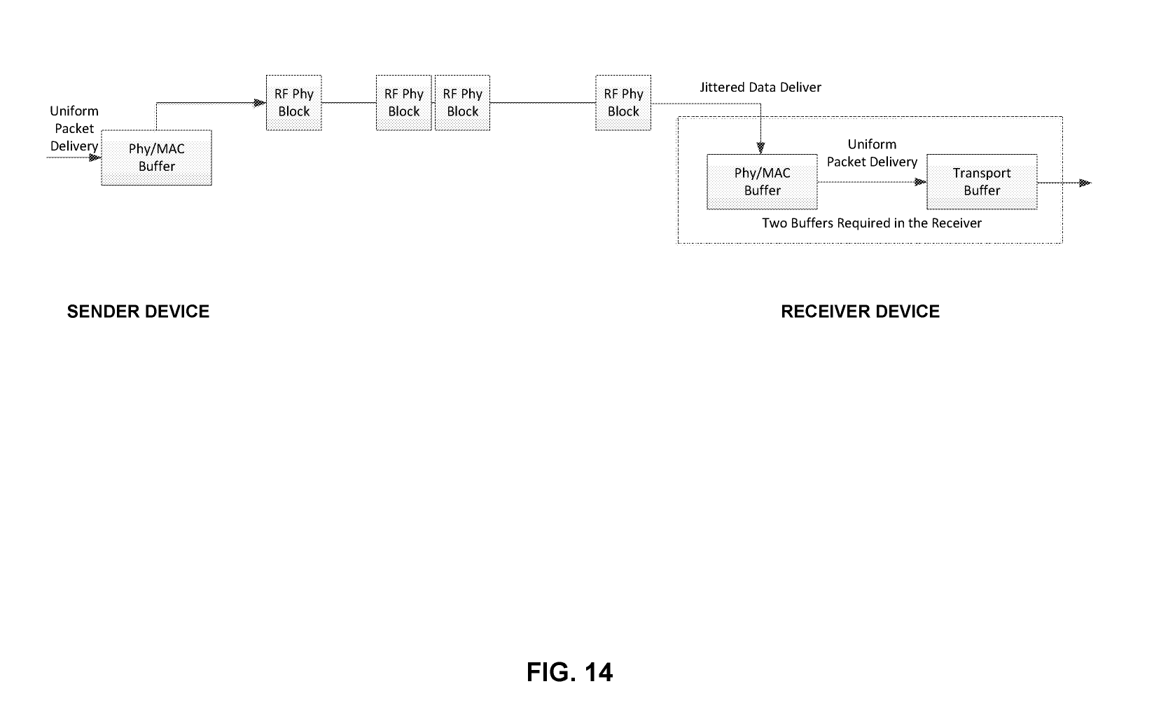

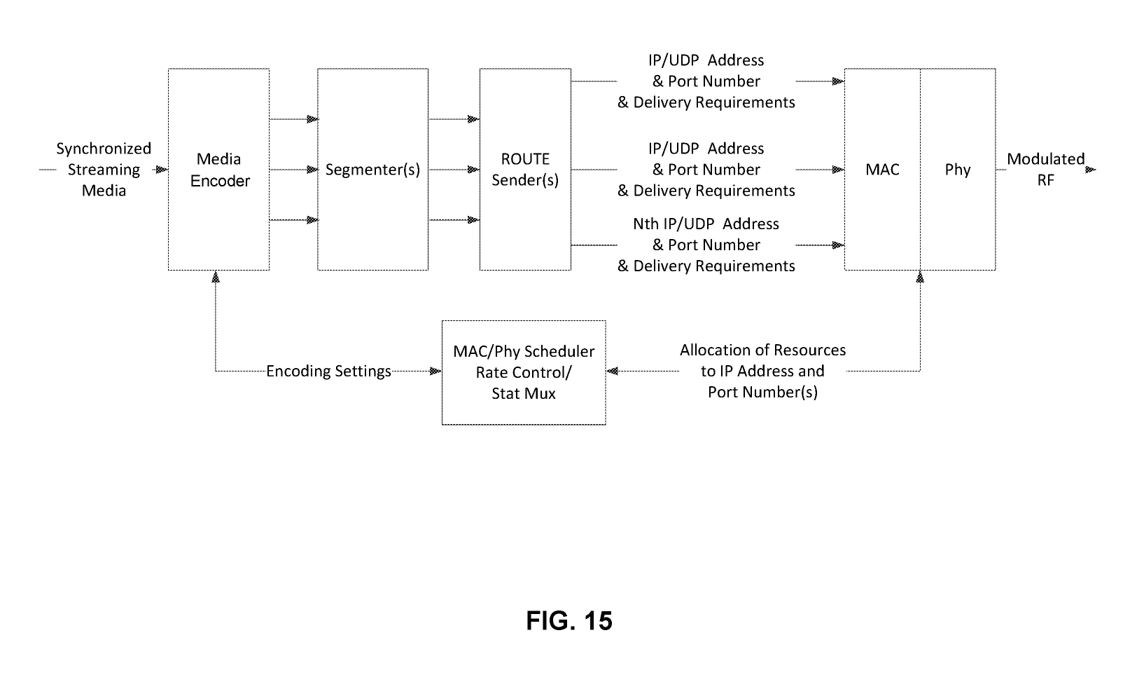

FIG. 14 is a conceptual diagram illustrating an example transmit system that is implemented according to the constant delay assumption and block delivery based physical layer. FIG. 14 portrays a Phy/MAC buffer of a sender device, as well as two buffers of a receiver device, including a Phy/MAC buffer and a Transport Buffer. There is a largely symmetric transmit stack for the sending side of the system of FIG. 14, as shown in FIG. 15, described below. These modern physical layers have evolved in such a manner that they may be viewed as a transport of blocks of data with a known size and knowable delay from input to output. This configuration of the bearing data channels is largely allocations of capacity with a known departure and delivery time from the defined characteristics of MAC/phy. These sorts of systems need not be viewed as a single or even multiple delivery pipes of constant delay. Furthermore, they may in fact have to implement input and/or output buffers in order to achieve constant delay, which can increase the overall latency and slow down channel change. An abstracted receiver model of such a system is shown in FIG. 14.

FIG. 15 is a block diagram illustrating an example transmitter configuration of a source device. In this example, the source device (also referred to as a sender device or server device herein) includes a media encoder, one or more segmenters, a ROUTE sender, and a MAC/phy unit. Contrary to the configuration of the system of FIG. 14, it is more effective to provide data to the MAC/phy interface with information about when it is needed at the destination and let the MAC/phy scheduler optimize the known (by possibly dynamic configuration) of the defined virtual delivery pipes. These are often mapped by IP address and port number.

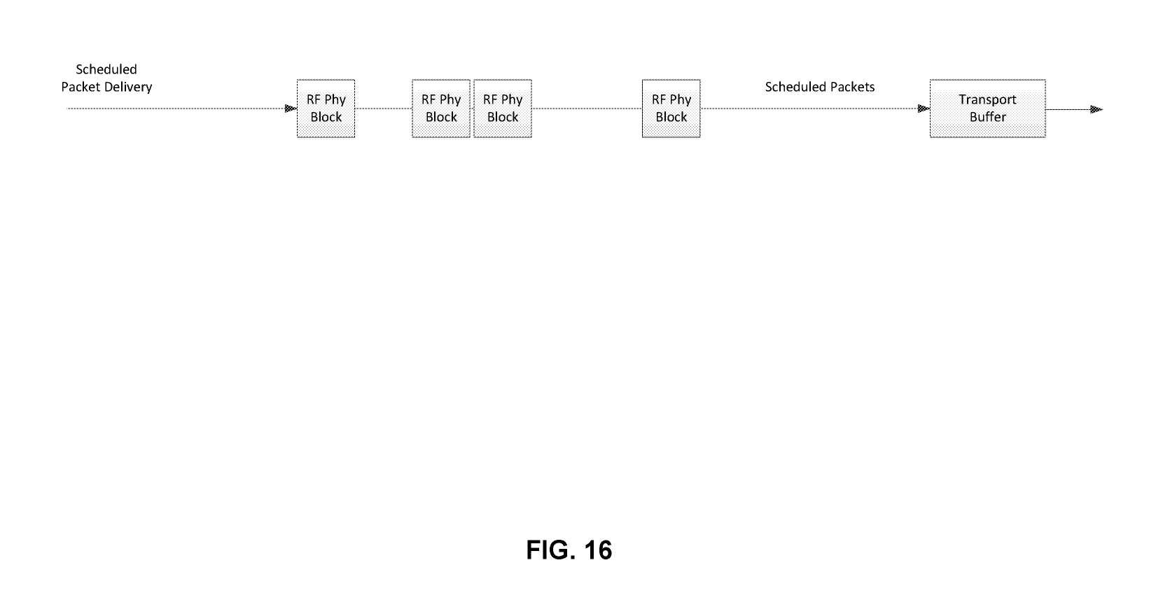

FIG. 16 is a conceptual diagram illustrating an example delivery model for data in a system with scheduled packet delivery. This particular configuration shows the use of ROUTE transmission protocol, which is suitable for the purposes of transmitting objects (files) via a block transport physical layer, but the protocol might also be FLUTE (File Delivery over Unidirectional Transport, defined in IETF RFC 6726), which has similar function, although with somewhat fewer features. The revised model for such a system is shown in FIG. 16. Both the transmitter and the receiver need not contain a receiver physical layer smoothing buffer, as shown in FIG. 16. The scheduled packets are delivered directly or with minimum delay to the transport buffer of the receiver. The resulting design is both simpler and may result in quicker start up, because the media is delivered closer to the actual need time.

Referring back to FIG. 15, the ROUTE, FLUTE, or other file delivery protocol can handle objects (files) to be delivered to the receiver. In the case of FLUTE, this is typically a single file at a time and a whole object, optionally with FEC. ROUTE and possibly other protocols may also deliver objects as a series of byte ranges. These byte ranges may be delivered to the ROUTE sender, for example, in an opaque manner. The ROUTE sender does not have to know the file type in order to handle the byte range. It merely delivers the byte range of the object to the other end of the link. Further the object and or the byte range may have a required or desired delivery time at the receiver transport buffer interface, as discussed above possibly expressed in the extension header. This is to say the entire object may have to be delivered to the receiver transport buffer interface by a certain time (this possibly conforming to the availabilityStartTime), or a portion of the object by a certain time (This possibly conforming to the extension header.) It is the case that multiple objects may be in the process of delivery concurrently to the receiver.

This current discussion is with respect to one delivery to one transport buffer. The objects being delivered can be DASH Segments (INTERNATIONAL STANDARD ISO/IEC 23009-1 Second edition 2014-05-01 Information Technology—Dynamic Adaptive Streaming Over HTTP (DASH) Part 1: Media Presentation Description and Segment Formats), and the file type may be exclusively ISO BMFF for streaming media, as described in ISO/IEC 14496-12:2012(E), INTERNATIONAL STANDARD ISO/IEC 14496-12 Fourth edition, 2012-07-15 Corrected version 2012-09-15, Information Technology—Coding of Audio-Visual Objects Part 12: ISO Base Media File Format.

The file type(s) of the “to be delivered” object(s) (e.g., files) need not be known by the ROUTE or other Sender, but the file type being delivered may have specific portions that are significant to the receiver. The block shown as “Segmenter” in FIG. 15 can determine the significance of the portions of media (byte ranges) being delivered and further can determine the required delivery time of the file or portion of the file in the terminal. Typically, prefixes of the file have a certain delivery time in order for the client to consume the file in a progressive manner. So, in an example, a specific prefix P1 of the file may be required to present the contained media up time T1. A second prefix P2>P1 may be required to present the contained media up to time T2>T1. An example of such a use case may be constructed utilizing streaming media such as video or audio being transported as series of ISO BMFF files of a specific temporal duration. Within these so called Segment files, a certain range of byte may have temporal significance to the media player, such as DASH. Such an example could be a video frame or group of frames (this possibly being the previously described MDE.) Some codec types may require N frames of encoder images in order to produce a single output video frame at a specific point in time or possibly before a specific point in time.

The Segmenter or similar media or file type aware formatter can provide a byte range to the ROUTE transport Sender with a required delivery time. The required delivery time may be expressed as either or both of an earliest time and/or a latest time at which a segment or byte range of a segment is to be delivered. This delivery time need not be specific for a particular byte range. For example, the requirement may specify, “this byte range should be delivered such that it is received at the transport buffer after time X and before time Y,” where X represents an earliest time and Y represents a latest time. Delivery to the transport buffer after time X may be relevant when joining a stream. If the data is received too early, then it may be missed in a joining event such as a switch on a Period boundary. By missing the Period start, the receiver cannot join the service which results in a bad user experience. The other bound, Y, can be related to, for example, synchronous play out across multiple devices. A hypothetical model receiver might not play media any later than dictated by this delivery bound. The hypothetical receiver having the ROUTE (receiver transport) buffer size, which is being guaranteed to neither under run or over run. The actual size of the required buffer being described for example in the ROUTE protocol. It is of course the case that the receiver may allocate more memory should it desire to further delay the playback time.

These times X and Y may be absolute or relative. Relative time to the moment posted to the interface seems to be the preferred solution. It should be understood that the Sender will determine the actual delay across the MAC/Phy, so as to not demand unserviceable requests. In general terms, the task for the physical layer scheduler may be simplified by the Sender posting media well in advance of the actual transmit time. The more time that the MAC/phy scheduler has to map media data, the better job it can do.

The Segmenter may indicate that delivery time should be close to Z. The Segmenter may also provide a priority with respect to this time. For example, there may be two byte ranges to be carried in the same ROUTE delivery, but one of these has priority with respect to being close to time Z this priority may be provided to the ROUTE Sender and subsequently to the MAC/phy interface in order for the MAC/phy interface to determine the optimal delivery ordering at the physical layer. Priorities may, for example, result in order to fulfill fast and consistent channel change experience. In some examples, delivery order may be enforced for a ROUTE session i.e., the order of the byte ranges/MDEs delivered to the scheduler must be preserved at the input of the ROUTE receiver in the receiver. For example, a syntax element (e.g., a flag) may indicate whether data of a ROUTE session is provided in delivery order, and that such delivery order is to be maintained.

Thus, although certain byte ranges may have semi-overlapping delivery times, if the syntax element indicates that the data is already in order and that order is to be maintained (i.e., preserved), then the delivery order needs to be maintained/preserved, even if an out-of-order delivery would still satisfy the delivery times as advertised. The functions preceding the scheduler are expected to provide early and late delivery times that allow in order delivery, if in order delivery has been indicated. In this manner, the syntax element (e.g., flag) represents an example of a syntax element indicating whether a delivery order of media data must be preserved when sending the media data to a client device from, e.g., the MAC/phy interface.

FIG. 15 as depicted shows that there is likely or can be a rate control mechanism functional in a closed loop around the cascade of the media encoders, Segmenters, ROUTE Sender, and MAC/phy. This is a common configuration, wherein multiple media streams are concurrently sent over a common or shared physical layer. This general method is often referred to as statistical multiplexing. The statistical multiplexer in general terms utilizes the statistical independence of the various media streams to fit more services into a single delivery system. The media encoder, in general, outputs defined encoding syntax. That is, the syntax data is subsequently placed in container files, such as ISO BMFF. These files are subsequently encapsulated in a transport protocol such as ROUTE or FLUTE. There is incremental data, for example, metadata and header information, added in both the Segmenter and Sender functions. The rate control system can only directly manage the size of the media and generally not the metadata or the header portions of the signal, although the data conveyed to the MAC/phy is comprised of all three types and some file and or byte ranges may contain no data which is under the control of the media encoders.

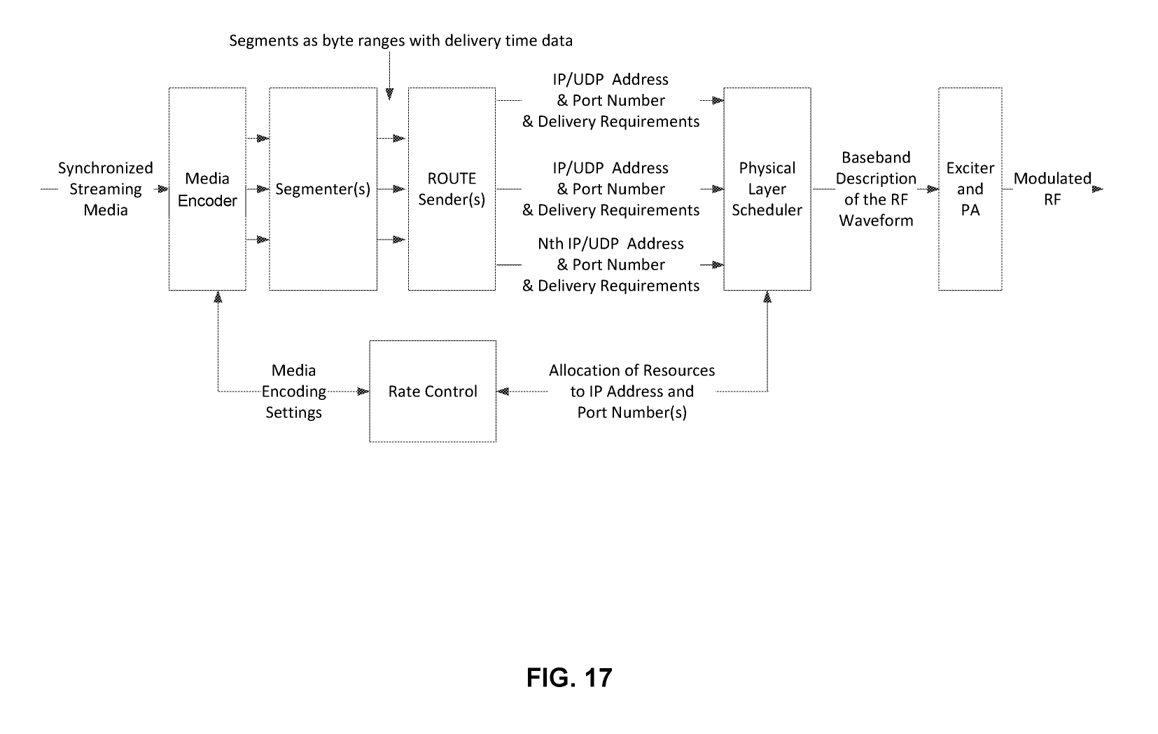

FIG. 17 is a conceptual diagram illustrating more details of a transmit system. A practical implementation of the functions of the MAC/Phy is shown in FIG. 17. The Physical Layer Scheduler solves the delivery scheduling of the physical layer, i.e., the Scheduler can determine what the physical layer can actually achieve in terms of delivery an defines the description of the RF signal at baseband. This baseband waveform can be distributed to multiple transmitters which will generate the same waveform at the same time to create a single frequency network (SFN). This method of generating the same waveform at the same time has been used by systems such as FLO or MediaFLO and LTE Broadcast/eMBMS.

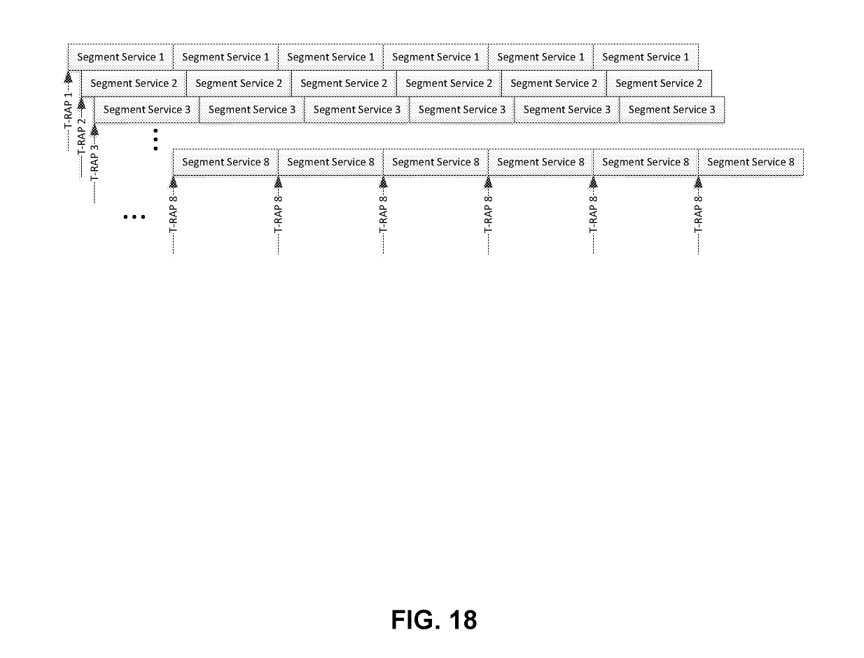

FIG. 18 is a conceptual diagram illustrating staggering of segment times. Staggering segment times may minimize peak bit rate requirements. There may be a need to organize the Segment times of the various services in such a manner as to minimize the possible collision of peak bandwidth demand. This has no impact on the design of the interface(s), but rather on the organization of the individual streams. This organization of Segment boundary times may have a specific relationship to the physical layer, as depicted in FIG. 18.

In FIG. 18, the Segments are depicted as linear in time as is the access to the physical layer. This phasing of the services tends to smooth the average data rate with minimum displacement of the RAPs or SAPs. The intra Segment data rates are not uniform versus presentation times. This is only one example method provided to illustrate that scheduling on the physical layer is the determinate of actual start up delay. The transport is merely delivering media up the stack at or before the last appropriate moment.

Examples of interfaces between the various components of the system are described below. The media encoder may or may not have an exposed interface between itself and the Segmenter. However, should the system include such an interface, the byte ranges that are significant for the Segmenter may be delivered discretely and directly to the Segmenter. The significant aspects may include the latest delivery time in order to deliver to the transport buffer soon enough and the earliest target delivery time, in order to not deliver the byte range or object to the transport buffer too early. These aspects may be determined analytically by the Segmenter, which transforms the encoded media into Segments, such as ISO BMFF files. These ISO BMFF files contain the specifics of delivery of media frames to the media decoder in the receiver. This interface outside the syntax of the media encoder itself may convey the size of a specific delivered media feature such as an associated media frame, a presentation time stamp, and/or a decode time stamp.

The interface between the Segmenter and the ROUTE Sender may provide the following information:
The applicable byte range or prefix for a significant feature
Fraction of the delivered data that is subject to a specific media encoder
   For a single type of media per file, this is a one to one mapping
   For a so called multiplexed Segment, a description of proportion for each of the media encoders, which have media in the Segment
Identifiers that allow the specific media encoder(s) that are the source(s) to be known, as to type and possibly address, likely IP address and port.
Earliest time that byte range may be delivered such that it is not received before an earliest specific time to the transport buffer in the receiver.
Target time that the media should be delivered at or immediately after such time that it is received at the transport buffer at the correct time.
The relative priority of this media stream as compared to others in this delivery with respect to an exact target delivery time.
Latest time that the byte range may be delivered.

The interface between the Sender and the MAC/phy may provide the following information:
The applicable byte range for the current delivery, possibly whole IP packets
Fraction of the delivered media that is subject to a specific media encoder
Identifier(s) that allow the identity(ies) of the specific media encoders to be known
Earliest time that the entire byte range may be delivered.
Target time that media should be delivered at or immediately after such that it is received in time at the receiver transport buffer at an appropriate time.
The relative priority of this media stream as compared to others in this delivery with respect to an exact delivery time.
Latest time that the byte range or prefix may be delivered such that it is received in time at the transport buffer in the receiver.

The defined cascade of interfaces allows the MAC/phy scheduler to have a complete picture of the media to be delivered, which can allow for the scheduling of the physical layer. The phy/MAC scheduler can see all the media that is being delivered in a relevant time span. If no early time is given, the target may be the earliest or the early time and the target may be set as the same value.

Example scheduler functionality, performed by the MAC/phy layer, is described below. The scheduler may map ahead as far as is deemed useful. This may increase the overall latency, which generally is not a problem as long as it is kept at a reasonable limit. However, planning ahead also may result in increased efficiency and especially in optimized channel change. The demands of the latest delivery constrain the choices for the phy layer with respect to currently sent media. The phy layer also may have discrete limits in terms of resolution for a delivery. This is a characteristic of an individual physical layer and is known for a given physical layer by the MAC/phy scheduler.

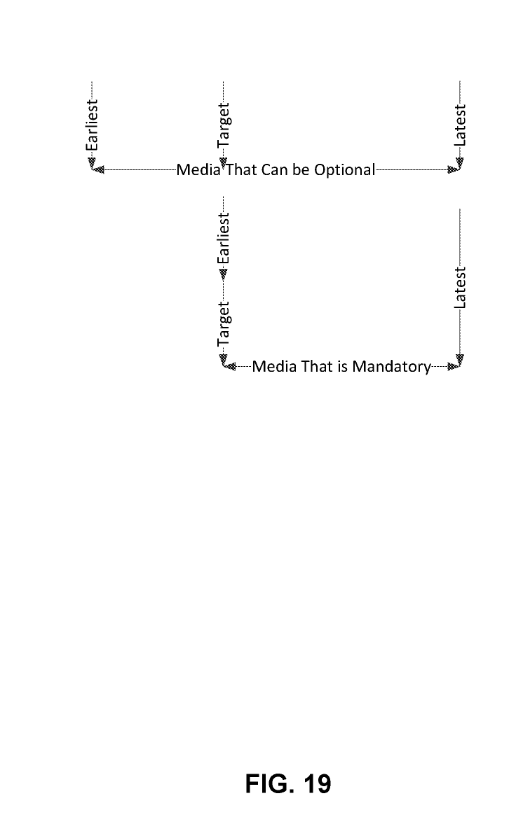

FIG. 19 is a conceptual diagram illustrating differences between target and earliest times when a stream includes media data that can be optional and media that is mandatory. In general, the delivery of streaming media has a timeline. There is an order in which media is consumed. Some media can be optional. It is undesirable to drop media, although if a stream is being continuously received, the dropped media is potentially brief and only at start up. The use of this feature can potentially interfere with so called common encryption, so use has to be restricted to cases in which the early delivered data does not interfere with DRM or mechanisms such as a file cyclic redundancy code (CRC), which could fail due to missing media. The most probable application for early or very early delivery is a large file delivery in which the latest delivery time is far past the forward time depth of analysis of the physical layer scheduler, i.e., the physical layer capacity is not fully utilized for streaming media and non-real time files that might be on a nominal delivery schedule of N bytes per delivery can opportunistically occupy more physical layer capacity. Media would be expected to run with adherence to the target and latest times. Target and early times in these cases would have the same value.

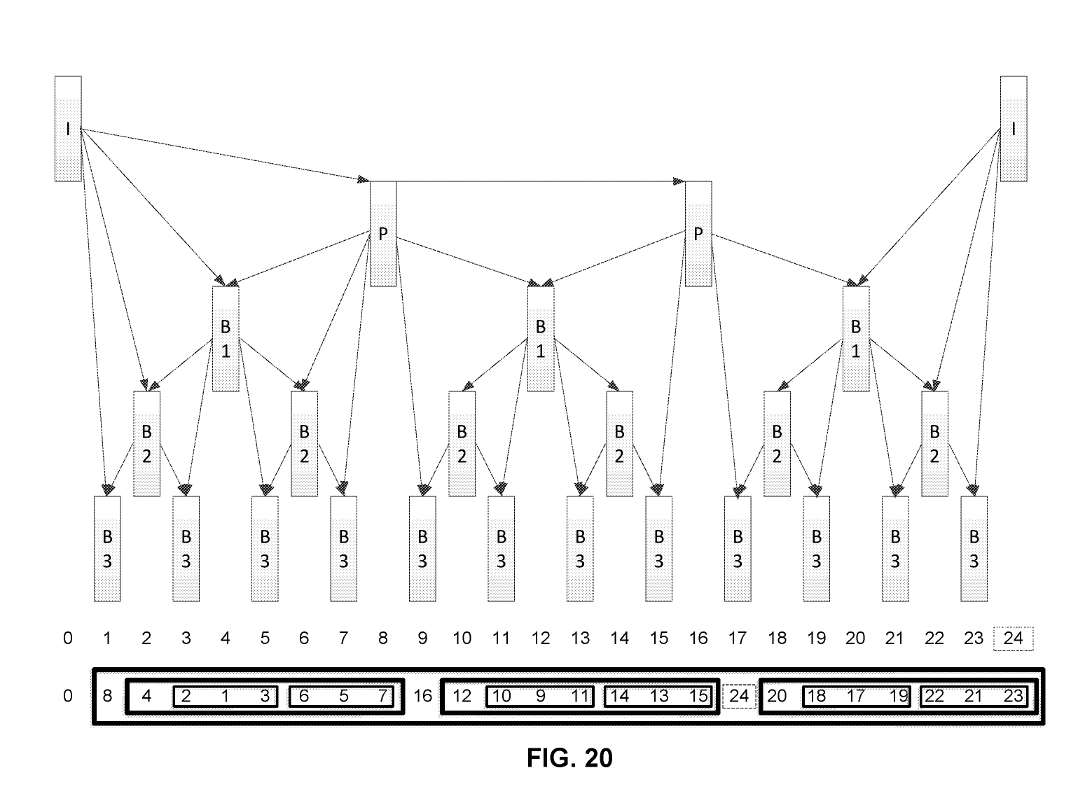

FIG. 20 is a conceptual diagram of a video sequence with potentially droppable groups of frames. In this example, arrows represent potential prediction between the frames. There are also two rows of numbers shown in FIG. 20. The top row indicates relative display orders of the frames above those numbers. The bottom row of numbers indicates the decoding order of the frames identified in display order. That is, the first frame (an I-frame) is both displayed and decoded first, the first P-frame is displayed eighth and decoded second, the first B-frame is displayed second and decoded fifth, and so on.

Certain media elements may be treated as optional. For example, in a group of frames, non-RAP frames may be considered optional. However, as shown in FIG. 20, due to dependencies between frames, when some frames are dropped, other frames that depend from the dropped frames will not be properly decodable and therefore may also be dropped. In FIG. 20, frames to be dropped as a group are outlined in the bottom row of numbers. For example, if frame 8 is dropped, all subsequent frames (in decoding order) are also dropped. On the other hand, if frame 4 is dropped, frames 2, 1, 3, 6, 5, and 7 are dropped. Likewise, if frame 2 is dropped, frames 1 and 3 area also dropped. In this manner, certain media elements may be treated as optional.

The availability of physical layers with block delivery of data may enable more specific mapping of media delivery than as practiced for MPEG-2 transport. This, in turn, may allow the delivery to be mapped to actual required time at a phy/MAC receiver interface. This specificity may reduce buffering requirements and can allow the start time to not be contingent on a conventional MPEG-2 TS buffer model. This, in turn, may result in an overall improvement in channel change time and may simplify the buffer model. The enhancements described herein may allow this scheme to be implemented on the network side of the system.

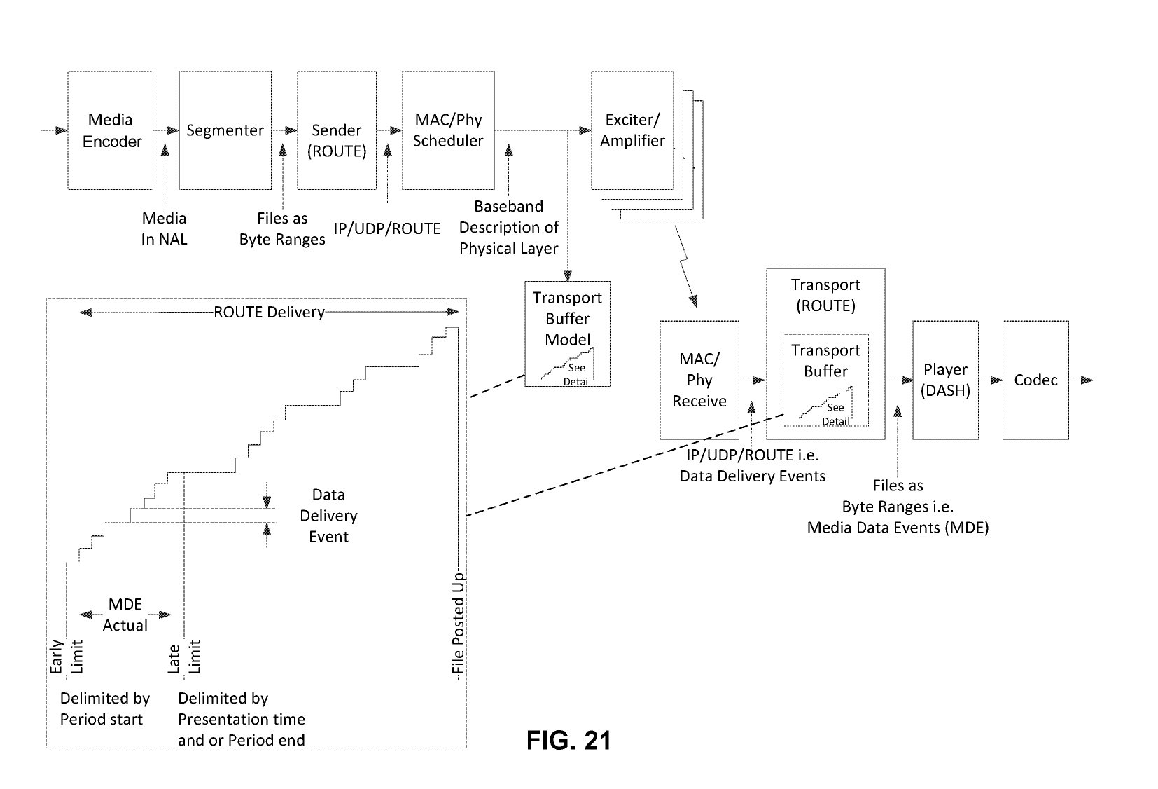

FIG. 21 is a block diagram illustrating another example system according to the techniques of this disclosure. The example system of FIG. 21 is similar to FIGS. 3, 15, and 17. That is, the example of FIG. 21 includes a sender device including a media encoder, a segmenter, a sender, a MAC/Phy scheduler, and an Exciter/amplifier, as well as a receiver device that includes a MAC/Phy receiver, a transporter, a media player (such as a DASH media player) and a codec (e.g., a decoder). FIG. 21 illustrates greater details regarding an example of the transport buffer model for these various components.

This disclosure describes certain techniques for describing byte ranges and objects that span multiple interfaces. The specific architecture of the implementation may or may not expose all the interfaces. Benefits that may result include the ability to allow the MAC/phy to schedule in a more efficient manner. Further, these techniques may allow the MAC/phy to schedule in a manner that will play without dropping media, unless this is a desired capability.

In this manner, the techniques of this disclosure include configuring interfaces to provide information describing required delivery times (e.g., earliest and/or latest times) for objects or byte ranges, as applicable. Objects may correspond to segments (that is, independently retrievable files, in accordance with DASH), and byte ranges may correspond to byte ranges of segments. Information describing a desired delivery time for an object or a byte range may include a relative priority of the object/byte range to other media streams in the delivery and/or to other services on this MAC/phy resource. Relative priority to other media streams may describe, for example, priority of video data relative to audio and/or timed text streams of the same media content. The information may also describe a latest delivery time. The information may further describe an earliest delivery time, which may include relative priority to other byte ranges for the encoder that encoded the object/byte range and other objects/byte ranges. The information may also describe a fraction of a byte range or object that is subject to a specific encoder, which may include a type for the encoder and/or an address of the encoder.

The techniques of this disclosure may further include interfaces among an encoder and a segmenter/packager, segmenters and senders (e.g., senders implementing ROUTE and/or FLUTE protocols), and senders (implementing ROUTE and/or FLUTE protocols) and MAC/phy layer devices.

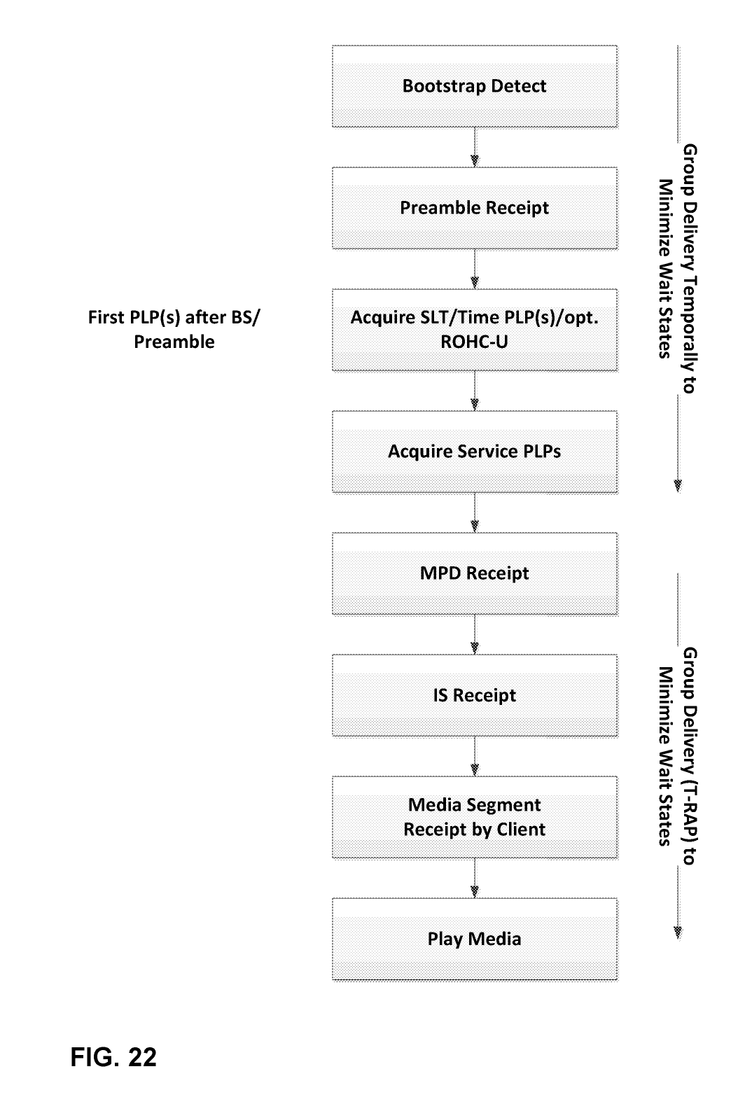

FIG. 22 is a flowchart illustrating an example technique for acquisition of media delivery events. That is, FIG. 22 shows example data and associated events to achieve a streaming media service. The techniques of FIG. 22 may be performed by, e.g., a receiver device, such as the MAC/Phy receiver or the ROUTE receiver of FIG. 3. In this example, there are two sequences of events. The first grouping is related to the physical layer. The Scheduler may be configured to determine that packets containing, for example, a service list table (SLT) and time need to occur in tight time proximity after the bootstrap and preamble. This shall be supported by identifying the relevant packet(s) as “Send in FEC Frame(s) Immediately Following the Preamble.” The cyclic temporal location of the bootstrap and preamble is likely aligned to media T-RAP timeline, so as to minimize wait states. Multiple staggered media start times and T-RAPS may require that multiple bootstraps and the associated signaling are required to minimize channel change time. If ROHC-U (robust header compression in unidirectional mode) header compression is being utilized, then there may be a need to synchronize the context refresh to functionally identify the T-RAP. This should be supported optionally as shown in FIG. 22.

As shown in FIG. 22, an example technique for acquisition of media delivery events, which may be performed by a sender device as discussed above with respect to, e.g., FIGS. 1, 3, 8, 14, 15, 17, and 21, may include bootstrap detection, preamble receipt, acquisition of SLT and time PLP(s) with optional ROHC-U, and acquisition of service PLPs, all of which may utilize group delivery temporally to minimize wait states. The PLP(s) may be the first PLP(s) after BS/preamble. In addition, the technique may include MPD receipt, IS receipt, media segment receipt, and media playback. Group delivery via T-RAP may be used to minimize wait states.

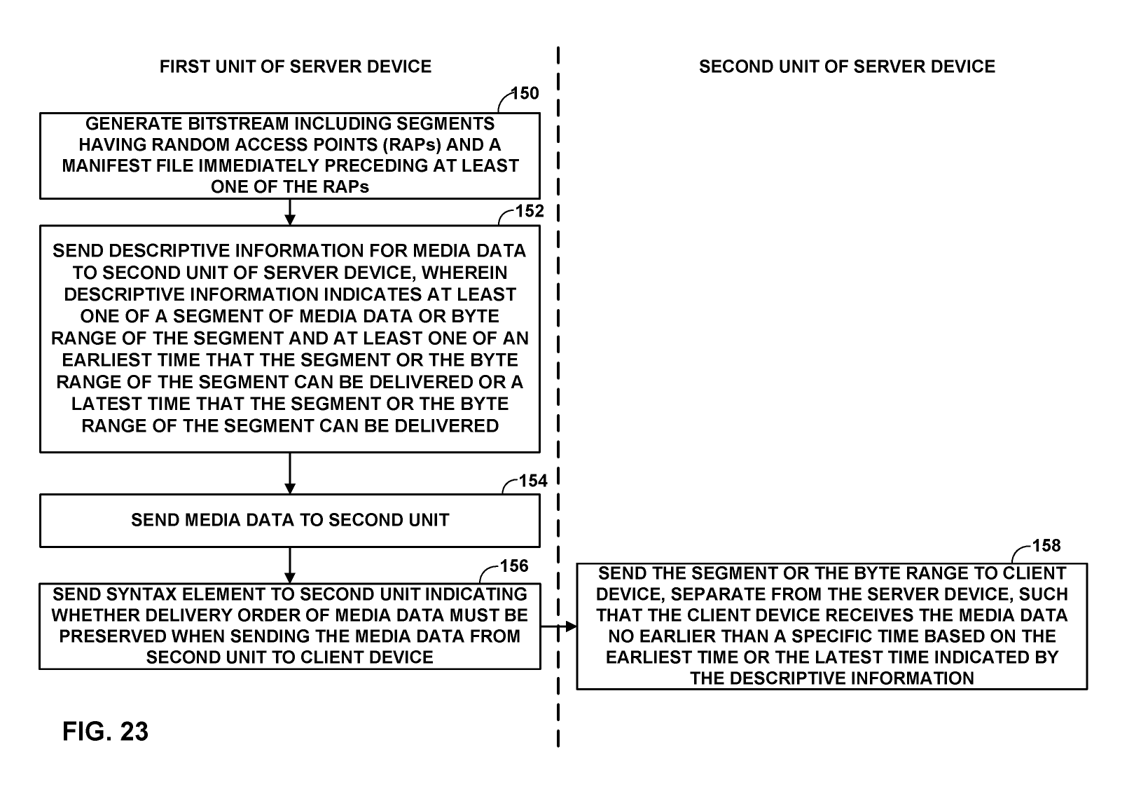

FIG. 23 is a flowchart illustrating an example method for transporting media data in accordance with the techniques of this disclosure. In particular, this example is generally directed to a method that includes sending media data from a first unit of a server media data to a second unit of the server, along with descriptive information for the media data. The descriptive information generally indicates when the media data can be delivered by the second unit to a client device. The first unit may correspond to, for example, a Segmenter (such as the Segmenters of FIGS. 3, 8, 15, 17, and 21) or a Sender (such as the Senders of FIGS. 3, 8, 15, 17, and 21). Alternatively, the first unit may correspond to a Sender (such as the Senders of FIGS. 3, 8, 15, 17, and 21) and the second unit may correspond to a MAC/phy unit (such as the MAC/phy units of FIGS. 3, 8, 15, and 21, or the physical layer scheduler of FIG. 17).

In the example of FIG. 23, initially, the first unit generates a bitstream including segments having random access points (RAPs) and a manifest file immediately preceding at least one of the RAPs (150). The manifest file may comprise, for example, a media presentation description (MPD). Although in this example the first unit generates the bitstream, it should be understood that in other examples, the first unit may simply receive a generated bitstream, e.g., from content preparation device 20 (FIG. 1). In some examples, the first unit may receive a bitstream and then manipulate the bitstream, e.g., to insert the manifest file immediately before at least one of the RAPs, e.g., as shown in FIG. 10.

The first unit then sends descriptive information for the media data of the bitstream to the second unit of the server device. The descriptive information indicates at least one of one of the segments of media data or a byte range of the at least one of the segments and at least one of an earliest time that the segment or the byte range of the segment can be delivered, or a latest time that the segment or the byte range of the segment can be delivered (152). The descriptive information may conform to the descriptions above. For example, the descriptive information may include any or all of a fraction of the segment or of the byte range that is subject to a specific media encoder, a target time that the segment or the byte range should be delivered at or immediately after, a latest time that the segment or the byte range can be delivered, a presentation time stamp for data within the segment or the byte range, a priority of a media stream including the segment relative to other media streams with respect to target delivery times for data of the media streams, and/or a decode time stamp for data within the segment or the byte range. The first unit also sends the media data (e.g., the bitstream or one or more segments, or portions of the segments) to the second unit (154).

The first unit may also send a syntax element to the second unit indicating whether a delivery order of the media data must be preserved when sending the media data from the second unit to a client device (156). The syntax element may be, for example, a one-bit flag that indicates whether data of a ROUTE session is provided in delivery order and that delivery order is to be maintained/preserved, as discussed above.

The second unit may then send the segment or the byte range of the segment to the client device, where the client device is separate from the server device, such that the client device receives the media data (i.e., the segment or the byte range of the segment) no earlier than a specific time that is based on the earliest time at which the segment or byte range can be delivered or the latest time that the segment or byte range can be delivered, as indicated by the descriptive information (158). For example, the second unit may ensure that the segment or byte range of the segment is delivered after the earliest time and/or before the latest time that the segment or byte range can be delivered. Thus, the second unit may ensure that the segment or byte range is delivered at a time during which the client can use the segment or byte range.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of transporting media data, the method comprising, by a first unit of a server device:
sending descriptive information for media data to a second unit of the server device, wherein the descriptive information indicates at least one of a segment of the media data or a byte range of the segment and at least one of an earliest time that the segment or the byte range of the segment can be delivered or a latest time that the segment or the byte range of the segment can be delivered; and
sending the media data to the second unit.

2. The method of claim 1, further comprising sending a syntax element to the second unit indicating whether a delivery order of the media data must be preserved when sending the media data from the second unit to a client device.

3. The method of claim 1, wherein the descriptive information further indicates a fraction of the segment or of the byte range that is subject to a specific media encoder.

4. The method of claim 1, wherein the descriptive information further indicates a target time that the segment or the byte range should be delivered at or immediately after.

5. The method of claim 1, wherein the descriptive information further indicates a priority of a media stream including the segment relative to other media streams with respect to target delivery times for data of the media streams.

6. The method of claim 5, wherein the media stream comprises a video stream, and wherein the other media streams include an audio stream related to the video stream.

7. The method of claim 5, wherein the media stream comprises an audio stream, and wherein the other media streams include a video stream related to the audio stream.

8. The method of claim 5, wherein the media stream comprises one of a plurality of streams including the other media streams, wherein each of the plurality of streams relates to the same media content, and wherein the plurality of streams includes one or more video streams and one or more audio streams.

9. The method of claim 8, wherein the plurality of streams further includes one or more timed text streams.

10. The method of claim 1, wherein the descriptive information further indicates at least one of a latest time that the segment or the byte range can be delivered, a presentation time stamp for data within the segment or the byte range, or a decode time stamp for data within the segment or the byte range.

11. The method of claim 1, wherein the first unit comprises a segmenter and wherein the second unit comprises a sender.

12. The method of claim 1, wherein the first unit comprises a Sender and wherein the second unit comprises a MAC/phy unit.

13. The method of claim 1, further comprising sending, by the second unit, the segment or the byte range of the segment to a client device, separate from the server device, such that the client device receives the media data no earlier than a specific time based on the earliest time or the latest time indicated by the descriptive information.

14. The method of claim 13, further comprising determining a delay between the server device and the client device, wherein sending comprises sending the segment or the byte range based on the earliest time or the latest time and the determined delay.

15. The method of claim 1, further comprising generating a bitstream to include a manifest file describing the media data such that the manifest file immediately precedes a random access point (RAP) of the media data.

16. The method of claim 15, wherein generating the bitstream comprises generating the bitstream to include robust header compression (ROHC) context initialization data immediately preceding the manifest file.

17. The method of claim 16, wherein the ROHC context initialization data is for a Real-Time Object Delivery over Unidirectional Transport (ROUTE) session used to transport the bitstream.

18. The method of claim 17, further comprising generating the ROHC context initialization data for one or more layered coding transport (LCT) sessions included in the ROUTE session.

19. The method of claim 16, wherein the ROHC context initialization data is for one or more layered coding transport (LCT) sessions used to transport the bitstream.

20. The method of claim 16, further comprising synchronizing a context refresh when ROHC-U (ROHC in unidirectional mode) compression is used.

21. The method of claim 15, wherein the manifest file comprises a media presentation description (MPD) according to Dynamic Adaptive Streaming over HTTP (DASH).

22. The method of claim 1, further comprising encapsulating the segment or the byte range with data according to one or more network protocols, wherein the descriptive information indicative of the earliest time or the latest time also applies to the data according to the one or more network protocols.

23. A server device for transmitting media data, the device comprising:
a first unit, and
a second unit,
wherein the first unit comprises one or more processing units configured to:
send descriptive information for media data to the second unit of the server device, wherein the descriptive information indicates a segment of the media data or a byte range of the segment and an earliest time that the segment or the byte range can be delivered or a latest time that the segment or the byte range of the segment can be delivered; and
send the media data to the second unit.

24. The device of claim 23, wherein the first unit comprises a Segmenter and wherein the second unit comprises a Sender.

25. The device of claim 23, wherein the first unit comprises a Sender and wherein the second unit comprises a MAC/phy unit.

26. The device of claim 23, wherein the descriptive information further indicates at least one of a fraction of the segment or of the byte range that is subject to a specific media encoder, a target time that the segment or the byte range should be delivered at or immediately after, a latest time that the segment or the byte range can be delivered, a presentation time stamp for data within the segment or the byte range, or a decode time stamp for data within the segment or the byte range.

27. The device of claim 23, wherein the descriptive information further indicates a priority of a media stream including the segment relative to other media streams with respect to target delivery times for data of the media streams.

28. The device of claim 23, wherein the one or more processors of the first unit are further configured to generate a bitstream to include a manifest file describing the media data such that the manifest file immediately precedes a random access point (RAP) of the media data and robust header compression (ROHC) context initialization data immediately preceding the manifest file.

29. A server device for transmitting media data, the device comprising:
a first unit, and
a second unit,
wherein the first unit comprises:
means for sending descriptive information for media data to the second unit of the server device, wherein the descriptive information indicates a segment of the media data or a byte range of the segment and an earliest time that the segment or the byte range can be delivered or a latest time that the segment or the byte range of the segment can be delivered; and
means for sending the media data to the second unit.

30. The device of claim 29, wherein the descriptive information further indicates at least one of a fraction of the segment or of the byte range that is subject to a specific media encoder, a target time that the segment or the byte range should be delivered at or immediately after, a latest time that the segment or the byte range can be delivered, a presentation time stamp for data within the segment or the byte range, or a decode time stamp for data within the segment or the byte range.

31. The device of claim 29, wherein the descriptive information further indicates a priority of a media stream including the segment relative to other media streams with respect to target delivery times for data of the media streams.

32. The device of claim 29, wherein the first unit further comprises:
means for generating a bitstream to include a manifest file describing the media data such that the manifest file immediately precedes a random access point (RAP) of the media data; and
means for generating robust header compression (ROHC) context initialization data immediately preceding the manifest file.

33. A computer-readable storage medium having stored thereon instructions that, when executed, cause a processor of a first unit of a server device to:
send descriptive information for media data to a second unit of the server device, wherein the descriptive information indicates at least one of a segment of the media data or a byte range of the segment and at least one of an earliest time that the segment or the byte range of the segment can be delivered or a latest time that the segment or the byte range of the segment can be delivered; and
send the media data to the second unit.

34. The computer-readable storage medium of claim 33, wherein the descriptive information further indicates at least one of a fraction of the segment or of the byte range that is subject to a specific media encoder, a target time that the segment or the byte range should be delivered at or immediately after, a latest time that the segment or the byte range can be delivered, a presentation time stamp for data within the segment or the byte range, or a decode time stamp for data within the segment or the byte range.

35. The computer-readable storage medium of claim 33, wherein the descriptive information further indicates a priority of a media stream including the segment relative to other media streams with respect to target delivery times for data of the media streams.

36. The computer-readable storage medium of claim 33, further comprising instructions that cause the processor to:
generate a bitstream to include a manifest file describing the media data such that the manifest file immediately precedes a random access point (RAP) of the media data; and
generate robust header compression (ROHC) context initialization data immediately preceding the manifest file.
